(19) United States
(12) Patent Application Publication
(10) Pub. No.: US 2026/0357641 A1
(43) Pub. Date: Nov. 12, 2026

(54) NOISE-REDUCING SYSTEM FOR FRAMES, DOORS, AND FRENCH WINDOWS, AND PROFILES AND INSTALLATION COMPONENTS THEREOF

(71) Applicant: Leodir Francisco do Prado, Pinhais - PR (BR)

(72) Inventor: Leodir Francisco do Prado, Pinhais - PR (BR)

(21) Appl. No.: 19/121,751

(22) PCT Filed: Aug. 28, 2023
(86) PCT No.: PCT/BR2023/000005

§ 371 Date: Apr. 16, 2025

(30) Foreign Application Priority Data
Oct. 27, 2022 (BR) 1020220218463

(51) Int. Cl. E06B 3/263; E06B 3/48; E06B 3/67

(52) U.S. Cl. CPC E06B 3/26347; E06B 3/487; E06B 3/6707

(57) ABSTRACT

Noise-reducing system for frames, doors and French windows, the profiles and installation components thereof resulting from elements that are combined for vertical sealing, in the door and window planes, of a jamb guide, sealing between panes, a rubber system, noise-reducing brush sealing (D), upper pane sealing, and an insulated bead; together with the separation of two-plane rail element profiles and two-plane rail support elements into two separate parts that can be combined with one another, and insulation on the contacts by means of the trim components (G); horizontal sealing being formed by the combination of stops on the corner, with a structured trim element (GE), sealing between panes, a corner joint, a central stop mid-column, a cross-member/column, and a corner plate, with a structured trim element (GE) with laminated bead components, an insulated bead and a plate bead.

### FIELD OF THE INVENTION

This invention deals with a construction arrangement belonging to the field of the industry of profiles for frames, doors, windows and their installation components.

### DESCRIPTION OF THE PRIOR ART

As is known from the state of the art of the aluminum profile industry and the production of window and door frames and their components, however, with limited constructions in terms of format, function, installation and optimization.

The models existing on the market consist of standard conventional modules which, in their various formats, have not brought the necessary evolution to meet the installation needs, adapting to irregularities in the spans of the buildings, in which the aforementioned items are installed. The improvements previously implemented and now existing, belonging to the state of the art, were not sufficient to efficiently contain the entry of noise, wind and dust into the environments where the existing products were installed. For this purpose, related prior art was found in the patent documents researched, namely, EP2740590B1 of May 8, 2011; U.S. 2008/292820, PI 0805330-8 of Dec. 22, 2008; MU 6300259-0 of Mar. 1, 1983; U.S. 20200302092 of Dec. 18, 2009; U.S. Pat. No. 10,260,276 of May 16, 2012; U.S. Pat. No. 6,123,135 of Mar. 2, 1999; U.S. Pat. No. 10,260,276 of Apr. 16, 2019; KR 101257496 of Apr. 24, 2013; NZ 622190 of May 27, 2016; CN 202493195 of Oct. 17, 2012; KR 20200025606 of Oct. 3, 2020; CN 102052045B of Oct. 30, 2009 and RU 2543311 of Mar. 25, 2010; CN 106460444A of May 5, 2014; U.S. Pat. No. 8,051,604 of Jan. 15, 2005; KR 20200123177 of Feb. 21, 2018; CN 105672815 of Oct. 29, 2014; CN 106460445 of May 5, 2014.

When evaluating the known solutions, it is observed that the construction arrangements of profiles and frames are limited to simplified construction arrangements, which do not offer the conditions offered by the present combination of elements. In the known previous models, the adopted acoustic insulation systems do not have satisfactory levels of wind containment, which pass through the frames into the interior of the rooms, carrying with them noise, dust, soot from vehicle exhaust and pollution. In the known models of frames, the structural frames that have channels called “door guides” have a distance at the top so that the sliding door leaves can be inserted in the gap passing close to the upper frame and side flaps, thus being accommodated in the guides of the lower frames.

In this accommodation of the leaves, gaps remain in the upper part as well as in the lower part, due to the seating on pulleys supported by rails. In an attempt to seal these gaps, to contain noise and dust, the existing traditional models sought to insert various types of sealing rubbers in the gaps next to the flaps along the profile, which did not prove effective in allowing the passage of wind to a certain degree. The same problem occurs with door and window panels that slide towards the side frames/jambs. Even when the rubber seals are pressed against the jambs, the sealing does not occur in a way that satisfactorily contains noise and dust. The same problem occurs in the gaps between two doors or window panels.

In traditional and well-known constructions, there is also a tab formed in the vertical profile that touches the vertical rubber seal, which never occurs completely, due to the imperfect adjustment of the window frames called uprights in the irregular gaps. During installation, when the uprights are fitted, they need to be adjusted due to the slopes of the sides of the gaps. The existence of irregular slopes, even if small, requires shims and adjustments that, when adjusting one of the sides, end up moving the other side away or moving the rubber seals away. Over time, these gaps tend to increase due to use and wear.

Another aspect verified in the attempt to solve the construction defects of the spans of the works is the height adjustment of the lower pulleys, which promotes vertical misalignment of the planes, creating new gaps through which wind, noise and dust pass. The result of using this ineffective traditional construction model known in the market, together with the lack of effectiveness of the installer in solving such noises, confirmed the conclusion that there would be no point in using thicker profiles, which would only make the structures heavier and more expensive, since reverberation would be considered just another unresolved aspect. Thus, the problem causing noise through the spans that was not solved was only added to the reverberation resulting from the standard thickness used in the profiles.

Other systems already on the market that sought to solve acoustic problems and problems with the entry of wind and dust were based on the principle of moving the rollers and lowering or tilting them when the doors and windows were moved, projecting the door or window to a pressure point against rubber or brushes at the tops. However, this palliative method has caused progressive wear on the rollers used to operate the levers that project the doors and windows. In addition, this ineffective method has always restricted the sealing to the first plane operated by the lever, that is, the other planes are not adequately placed against each other for perfect sealing.

In the search for a solution to contain noise, the profiles were also filled with foam and brushes to minimize the effect of wind entry, which was also not effective given the increase in noise pollution and the imminent need for greater acoustic insulation. In addition to these problems detected, it was observed that the lower rollers used in sliding doors and windows were built to be supported by baguettes, which, due to the time of use in the sliding of the roller, were replaced by fitting and locking the baguettes in the lower channels of the profiles. However, this alternative also proved to be inefficient as use promoted deformation in the baguettes that, when partially disengaged, cause new noises that were previously non-existent.

After extensive investigation into works and research into existing frames, the applicant detected several problems and concluded that the decibels measured inside the environment were the result of a sum of defects, which contributed proportionally to an unacceptable noise level, making the state-of-the-art products outdated in terms of sealing against wind, dust and various noises.

In addition to the noise problem, which tends to increase with use over time, it was found that the entry of dirt, dust and pollution increased due to new gaps resulting from the natural movement of buildings and structures, so an attempt was made to develop a system to solve all existing problems. To this end, the Applicant combined a series of improvements for implementation in the industry of profiles for frames, doors, French windows, their accessories and installation components, developing a complete solution that allows the perfect adaptation of frames, doors, French windows to the openings of the constructions using specific means and adjustments made possible by the new construction system of the profiles, their components that contribute to the assembly and installation process, including compensating for possible failures in the civil construction with the structural improvement of the profiles and their components, and which translates into the main objective of the present invention patent together with the assembly and installation process.

### DETAILED DESCRIPTION OF THE INVENTION

The new system that makes up this new invention patent is based on the process and construction arrangements with specific arrangements which act together to obtain the maximum degree of containment of wind, dust and noise. Individually, the new processes and their respective construction arrangements solve the problems, achieving efficiency through the sum of partial improvements resulting from the number of components used in the system. Therefore, the interaction of all the components results in greater efficiency in blocking wind, dust and noise when using this system, which is built for door plans with two, three or more leaves, including a hand-held type hitch and its modulations for maximum-air windows, swing doors, fixed doors, corner sliding doors, sliding doors with central locking.

For this set of frames, profiles and components that make up this system to which this invention patent refers, the aim is to streamline the manufacturing of components, making installation more practical as well as maintenance and/or replacement of components.

The applicant, aiming to implement a new efficient construction system applied to window and door frames and their components, developed this invention patent configured in various aspects of sets, whose characteristics and component elements ensure greater acoustic insulation with adequate adjustment and finishing in the gaps adapted to each construction, as well as enabling greater practicality and speed of installation.

This system patent developed and implemented, as its main basis, the frame guide element (09) as a fundamental solution to the acoustic problem, wind and dust entry for all door and window planes that are built with aluminum profiles or their alloys, both in the upper part and in the lower part and on the sides, based on a process and construction arrangement that is different from the models currently on the market. Therefore, in the present solution that is the object of this patent, there is no displacement of accessories from the planes, pulleys, locks or handles, resulting in greater durability of the frames, their components and accessories as it is more effective according to the system specifications, described below.

In addition to the functional objectives, the solution allows for better adjustment and finishing in the construction gaps, as well as greater practicality and speed in installation, provided mainly by the unprecedented process of inserting and screwing the upper frame guide (09) behind the leaf. of the French window or door, which significantly reduces the upper gap of the frame in the opening, and consequently, the lower gap with the reduction in the height of the pulley, since it will no longer need to be raised or tilted due to the installation of the frame guide (09). The solution foresees that the upper guide of the door is installed after the leaf, which may be larger or smaller depending on the span or any construction irregularities in the work. The aforementioned guide frame (09) is not a view, and allows for precise and differentiated adjustment which can be combined with the lower pulley height adjustment. This type of process that results in a new construction arrangement is characterized as an invention, since the installation process uses the frame guide (09) and upper sheet sealing element (10) applied to the three-plane frame element (17) and the two-plane frame element (6).

In order to solve the aforementioned problem of gaps, the present invention patent implemented the fixing by means of a two-part screwing process, and also separated the two-plane rail profiles (02) and two-plane rail support (03) into two distinct parts which have, combined with each other, insulation in the contacts by means of the component elements trims (G), which excluded any remaining vibration which interrupted the reverberation of the glass, even the friction of movement of the work disappeared with the process of dividing the component elements two-plane rail profiles (02) and two-plane rail support (03), as shown in FIG. 30/35 (in detail on page 24), in the division of the two-plane rail (02), two-plane rail support (03) as well as in the connection that occurs between the maximum-air frame profile (41) and maximum-air sheet (42) with the counterframe (01). In conjunction with the improvements proposed in this new system, it was found that in the state of the art and commercialized on the market, the profiles were constructed in a single piece, which resulted in persistent noise that did not allow reduction below 22 decibels. It was detected that the noise level was the result of reverberation in the glass, which, despite having increased its thickness, did not satisfactorily reduce the result.

Some components of the new anti-noise system also provide solutions for other problems, such as water retention at the base of the frame gutters, for which the gutter profiles (item 14), three-plane rail (item 15) and gutter extension (item 16) were developed, which together allow perfect drainage without the need for alternative drilling to open drainage ducts, where impurities would also circulate.

The rubber gasket used to press the profiles and seal the frame was developed with micro partitions that favor the deformation and self-filling of the internal space due to its construction.

Following the same unprecedented principle, the brooms gained extension and amplitude due to their construction in an elongated and dense format, reducing the entry of air and dust.

When considering all the improvements implemented from the present invention patent, it is observed that the effectiveness of the anti-noise system occurs due to the combination of vertical sealing and horizontal sealing by means of its elements, rails, components and accessories. Thus, each modality results from the arrangement and combination of profile elements, components and accessories in constructive arrangements to adapt to all the needs of design, use and installation location. When observing the physical propagation of wind and sound, the direction and effects caused by the vertical seal, it is thus named because wind and sound propagate vertically upwards and downwards, in the door and window planes, having as a solution the combination of frame guide (9), seal between leaves (45), rubber system, anti-noise broom seal (D), upper leaf seal (10), insulated baguette (12). The vertical sealing process modality occurs from the significant reduction of the gap from the guide frame elements (9) and upper sheet seal (10) together with the separation of the two-plane rail element profiles (02) and two-plane rail support element (03) into two distinct parts which have, combined with each other, insulation in the contacts by means of the component elements gaskets (G). The vertical sealing element (45) represented on pages 26 to 29 and 46 is an element fixed to the internal and not visible profile of the sliding sheet (11), serving to seal the gaps against the passage of wind, dust and sound, helping to reduce noise by compensating for the gap in the upper and lower part of the rails, as well as in the cleaning of the two-plane rail element (02), three-plane rail element (15), upper or lower from the use of the brush wedge (CE) conferring greater durability of the pulley rail (04);

The corner sealing element incorporates the use of the shim/brush assembly element and the sealing assembly element (45) with a brush between the leaves, both in the upper and lower parts of the planes, in one of the planes, and in the other planes, a corner joint profile element (21) that allows the simplified intersection of two planes. This construction arrangement foresees a type of door that has a door view applied and adjusted with frontal pressure, which has a specific volumetry creating an internal air pocket that ensures the reduction of noise transmission.

The horizontal sealing process modality aims to contain the physical propagation of wind and sound in the direction and effects it causes and is thus named because the wind and sound propagate horizontally to the sides in the door and window planes, with the solution being the combination of corner stops, handrail, seal between leaves (19), corner joint (21), central stop (23), half column (25), crosspiece/column (26) and corner bracket (27). In the horizontal seal, the “helping hand” type closure model is included, for which the structured trim element (GE) represented on page 36 was developed, the straight vertical front meeting element; in its corner conformation (page 37), the adoption of the device called “helping hand” for the meeting of leaves, which has as a differentiation a shim for vertical adjustment, to be compensated for any irregularities in the vertical beams of the construction opening where the French window or door will be inserted. The perfect suitability of the rubber gasket, which, due to the closing of the French window or door when pressed against the face of the vertical frame, promotes a wide and homogeneous seal; component elements such as laminated baguette (38), insulated baguette (39) and sheet baguette (40) are also used, which provide greater pressure, increasing acoustic insulation because they are screwed and not just fitted, which over time and use generates slack and new noises. The previously existing system used in doors and belonging to the state of the art, was focused on the pressure baguette with fitting with the unique possibility of increasing the thickness of the rubber, which, in addition to the structured gasket element (GE), configures a corner joint profile element (21) which moves together with the leaf, forming an aesthetically symmetrical element on both sides. This vertical profile element (11) is configured as a corner element, being fixed to one of the sheets that fits into the other sheet that moves towards it. In addition to having a thickened thickness and containing a structured trim (GE).

The process modality when implementing upper fixation by separation between the frame guide element (09) and the upper sheet sealing element (10) applied to the three-plane frame element (17) and the two-plane frame element (6) resulted in a minimum reduction of tenths of a millimeter, which is still obstructed by the brush component element (D), that is, the smaller the gap in the upper and lower parts of the planes, the lower the entry of wind, dust and noise; and it was found that in the solutions belonging to the state of the art and known in the sector in PVC and aluminum or its alloys, there is no such process or element that promotes the reduction of gaps.

The process modality increasing the thickness (ME), mass and undulation (AB) in the profiles with internal application of rubbers (G), to obstruct the entry of wind, dust and sound and their dissipation and reverberation, enhancing the effects of the gap reduction; increasing the thickness (ME) in profiles with greater mass for acoustic obstruction represented in FIG. 49, sliding leaf element (11); FIG. 54, turning leaf element (37), modality of profiles with greater mass for acoustic obstruction represented in FIG. 56, the sliding leaf element (11), the half-column element (25), the turning leaf element (37), the crossbar/column element (26), the maximum-air leaf element (42); FIG. 48 shows the counterframe element (01) and the pulley rail element (04); FIG. 51 shows the corner union element (21); FIG. 52 shows the half-column element (25) and the crossbar/column element (26); FIG. 53 shows the pivot frame element (31); FIG. 54 shows the pivot leaf element (37) and the max-ar frame element (41); FIG. 55 shows the max-ar leaf element (42) and the counterframe element (44). In existing constructions, there was never any concern about the increase in mass and undulation of the elements, since such retention gain was disregarded amidst so many other noises without a detected and resolved origin, but which for the present system contributes to an even more efficient result. In the present system, together with the specific profile flaps and their undulating shapes that ensure less reverberation and block the entry of noise and dust into the environment, it reduces the existing noise of traditional lines by 50%, reducing it from the range of 40 decibels to 20 decibels or less. Such an improvement had never been seen in other frames, which never prioritized increasing the thickness of the profiles, due to the unjustified overload of the weight of the structure and the increase in cost in the face of insignificant noise reduction.

Based on the processes and elements developed and reported in this patent, the combination of the profile elements, components and accessories results in several construction arrangements in the form of processes in the following modalities:
In the modality of FIG. 1, a sliding door with two planes and four leaves is represented, the fixing by screwing process in two parts was implemented, and the profiles of the two-plane rail (02) and the two-plane rail support (03) were also separated into two distinct parts which have combined with each other, insulation in the contacts by means of the component elements (G), which excluded any remaining vibration which interrupted the reverberation of the glass, even the friction of movement of the work disappeared with the process of dividing the component elements profiles two-plane rail (02) and two-plane rail support (03), as can be seen in FIGS. 30 and 35 and in detail on page 24, in the division of the two-plane rail (02), two-plane rail support (03) as well as in the connection that occurs between the maximum frame-air profile (41) and maximum leaf-air (42) with the counterframe (01).
In the embodiment of FIG. 2, a two-plane, two-leaf sliding door is represented;
In the embodiment of FIG. 3, a three-plane, three-leaf sliding door is represented;
In the embodiment of FIG. 4, a two-by-two fixed-leaf window is represented;
In the embodiment of FIG. 5, a maximum-air window is represented;
In the embodiment of FIG. 6, a maximum-air/fixed window is represented;
In the embodiment of FIG. 7, a maximum-air/maximum-air window is represented;
In the embodiment of FIG. 8, a fixed/maximum-air window is represented;
In the embodiment of FIG. 9, a maximum-air/fixed window is represented;
In the embodiment of FIG. 10, a swing door with acoustic profiles and screwed fixing baguettes with different thicknesses of support for glass is represented, laminated baguette elements (38) are represented;
In the embodiment of FIG. 11, a baguette swing door with insulated baguette element (39) is represented;
In the embodiment of FIG. 12, a baguette swing door with sheet baguette element (40) is represented;
In the embodiment of FIG. 13, a sliding door with two planes and four leaves is represented;
In the embodiment of FIG. 14, a sliding door with two planes and a ninety-degree corner is represented; (containing a brush seal with felt, a counterframe with greater mass, trims for acoustic reduction with a specific trim model and a specific profile model);
In the embodiment of FIG. 15, a sliding door with two lateral planes is represented (containing a brush seal with felt, a counterframe with greater mass, trims for acoustic reduction with a specific trim model and a specific profile model);
In the embodiment of FIG. 16, a sliding door with two lateral planes is represented (containing a brush seal with felt, a counterframe with greater mass, trims for acoustic reduction with a specific trim model and a specific profile model);
In the embodiment of FIG. 17, a sheet meeting is shown (containing a brush seal with felt, acoustic trims, a specific trim model, a specific profile model and a specific profile meeting model);
In the embodiment of FIG. 18, a sheet meeting is shown (containing a brush seal with felt, acoustic reduction trims, a specific trim model and a specific profile model);
In the embodiment of FIG. 19, a sheet meeting at ninety degrees is shown (containing acoustic reduction trims, a specific trim model, a specific profile model (21) fixed to one sheet allows the fitting of the other sheet with brush and trim for acoustic insulation);
In the embodiment of FIG. 20, two upper planes are shown (containing a felt brush seal, a five-millimeter mass counterframe, acoustic reduction trims, a specific profile model and a specific upper adjustment model);
In the embodiment of FIG. 21, two lower planes are represented (containing a seal with a felt brush, a counterframe with a five-component mass) millimeters, acoustic reduction trims, specific profile model, and specific rail and rail support model);
In the embodiment of FIG. 22, the profile meeting is shown (containing the adjustment of the profile meeting, such as a hand-held profile, trim and brushes with felt);
In the embodiment of FIG. 23, the upper/upper sliding adjustment is shown (containing the upper profile with measurement adjustment, brush with felt, acoustic insulation and windbreak, frame guide placed after the frame is installed, which allows acoustic sealing);
In the embodiment of FIG. 24, the rail and rail support are shown (containing acoustic sealing strips on the pulley guide and damping trims for the pulley guide, rail and rail support, acoustic brushes) and (containing rail drilling and support for water drainage);
In the embodiment of FIG. 25, the lower application of the sealing assembly is shown, in front section; lower application of sealing assembly, (containing shim and brush assembly, and sealing assembly (45/with brush between leaves);
In the embodiment of FIG. 26, a sealing assembly (acoustic, windbreak and cleaning brush) is represented;
In the embodiment of FIG. 27, a sealing assembly (acoustic, windbreak and cleaning brush) is represented;
In the embodiment of FIG. 28, a sealing assembly is represented in frontal section; containing shim and brush assembly, and sealing assembly (45/with brush between leaves);
In the embodiment of FIG. 29, an upper application of a sealing assembly containing shim and brush assembly, and sealing assembly (45, with brush between leaves) is represented;
In the embodiment of FIG. 30, (expanded three-plane sliding assemblies) containing expanded three-plane sliding assemblies are represented;
In the embodiment of FIG. 31, a three-plane sliding door with three leaves containing 3-plane sliding expanded assemblies;
In the embodiment of FIG. 32, a sliding door with three planes and three leaves containing 3-plane sliding expanded assemblies is shown;
In the embodiment of FIG. 33, a sliding door with three planes and three leaves containing 3-plane sliding expanded assemblies is shown;
In the embodiment of FIG. 34, two-plane sliding expanded assemblies are shown, containing 2-plane sliding expanded assemblies;
In the embodiment of FIG. 35, two-plane sliding expanded assemblies are shown, containing 2-plane sliding expanded assemblies;
In the embodiment of FIG. 36, expanded assemblies with center-mounted leaf abutments are shown, containing expanded assemblies with center-mounted leaf abutments;
In the embodiment of FIG. 37, expanded assemblies with ninety-degree leaf abutments are shown, containing 90-degree leaf abutments;
In the embodiment of FIG. 38, expanded assemblies of a sliding door with two planes and four leaves are represented, containing expanded assemblies of sliding doors with two planes;
In the embodiment of FIG. 39, expanded assemblies of fixed planes are represented, containing expanded assemblies;
In the embodiment of FIG. 40, expanded assemblies of fixed planes are represented, containing expanded assemblies;
In the embodiment of FIG. 41, expanded assemblies of a maximum air window are represented, containing expanded max-air assemblies;
In the embodiment of FIG. 42, expanded assemblies of a maximum air window are represented, containing expanded max-air assemblies;
In the embodiment of FIG. 43, expanded assemblies of a swing leaf are represented, containing expanded swing leaf assemblies;
In the embodiment of FIG. 44, expanded assemblies of a swing leaf are represented, containing expanded swing leaf assemblies;
In the embodiment of FIG. 45, expanded swing leaf assemblies are represented, containing expanded swing leaf assemblies;
In the embodiment of FIG. 46, expanded swing leaf assemblies are represented, containing expanded swing leaf assemblies;
In the embodiment of FIG. 47, a trim with cutouts to induce compression shape is represented, containing trim with cutouts to induce compression shape;
In the embodiment of FIG. 48, profiles are represented (counterframe, two-plane rail, two-plane rail support, roller rail finish, two-plane frame);
In the embodiment of FIG. 49, profiles are represented (finishing, drip tray, frame guide, upper leaf seal, insulated baguette, sliding leaf/rail support);
In the embodiment of FIG. 50, profiles are represented (gutter, three-plane rail, gutter extension);
The model in FIG. 51 shows profiles (three-plane frame, seal between leaves, corner joint cover, central seal cover, central stop, corner joint);
The model in FIG. 52 shows profiles (laminated baguette, half column, crosspiece/column, corner piece, wedge, three-plane rail support);
In the embodiment of FIG. 53, profiles are represented (floor finish (30), adjustment angle (32), adjustment frame (33), finish (35), pivot frame (31), pivot support (34), drip pan (36)
In the embodiment of FIG. 54, profiles are represented: pivot sheet (37), laminated baguette (38), sheet basket (40), insulated baguette (39), max-ar frame (41);
In the embodiment of FIG. 55, profiles are represented: max-ar sheet (42), counterframe (44), gutter cover (43), seal between sheets (45), shim (46)
In the embodiment of FIG. 56, profiles are represented (with greater mass and undulation for acoustic obstruction) (pivot sheet, laminated baguette, insulated baguette, sheet baguette, maximum air frame); profiles (maximum air sheet, gutter cover, counterframe, seal between leaves, shim); profiles (with greater mass and undulation for acoustic obstruction).

To complement this description in order to obtain a better understanding of the characteristics of this claim, this description is accompanied in the annex, by a set of drawings, where in an exemplified manner, although not limitative, the following is represented.

### DESCRIPTION OF THE DRAWINGS

With reference to the drawings, this disclosure shows a noise proofing system for frames, doors, windows their profiles and installation components, in which:

FIG. 1 shows in plan and side section and in front view, the noise protection system applied to a two-plane, four-leaf sliding door;

FIG. 2 shows in plan and side section and in front view, the noise protection system applied to a two-plane, two-leaf sliding door;

FIG. 3 shows a plan view, side section and front view of the noise-reduction system applied to a three-plane, three-leaf sliding door;

FIG. 4 shows a plan view, side section and front view of the noise-reduction system applied to fixed windows;

FIG. 5 shows a plan view, side section and front view of the noise-reduction system applied to a maximum air window;

FIG. 6 shows a plan view, side section and front view of the noise-reduction system applied to a maximum air/fixed window, horizontally;

FIG. 7 shows a plan view, side section and front view of the noise-reduction system applied to a maximum air/maximum air window;

FIG. 8 shows a plan view, side section and front view of the noise-reduction system applied to a fixed/maximum air window, vertically with upper fixed;

FIG. 9 shows a plan view, side section and front view of the noise-reduction system applied to a maximum air/fixed window, vertically with upper fixed;

FIG. 10 shows a plan view, side section and front view of the system applied with glass or mirrors in a swing door;

FIG. 11 shows a plan view, side section and front view of the noise-reduction system applied to a baguette swing door (element 39);

FIG. 12 shows a plan view, side section and front view of the noise-reduction system applied to a baguette swing door (element 40) with acoustic wood in the center;

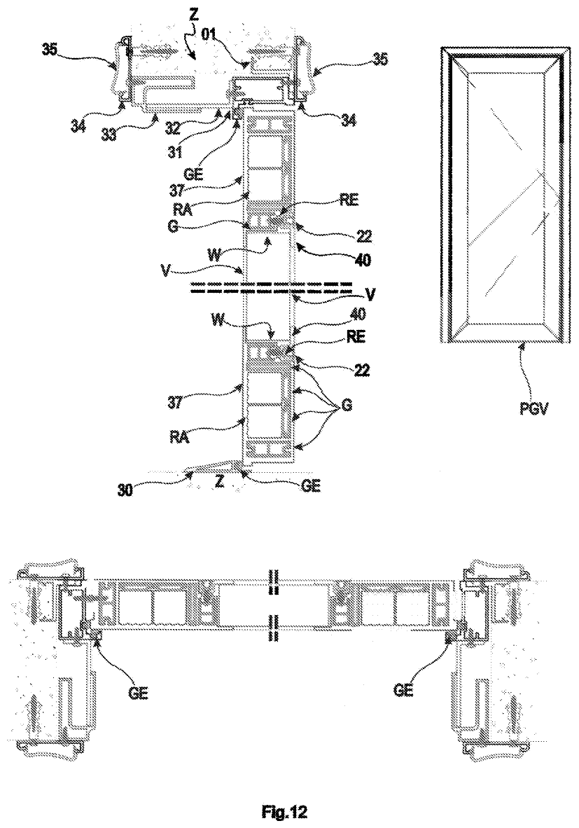

FIG. 13 shows a plan view of the noise-reduction system applied to a two-plane, four-leaf sliding door;

FIG. 14 shows a plan view of the noise-reduction system applied to a two-plane, ninety-degree corner sliding door;

FIG. 15 shows a plan view of the noise-reduction system applied to a two-plane, four-leaf sliding door;

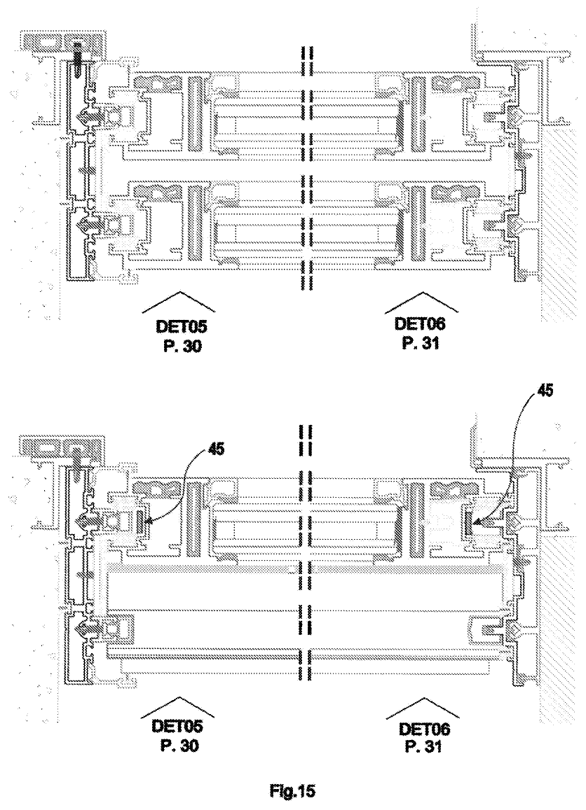

FIG. 16 shows a cross-section of the noise-reduction system applied to two lateral planes (containing brush sealing with felt, counterframe with greater mass, trims for acoustic reduction with a specific trim model and a specific profile model);

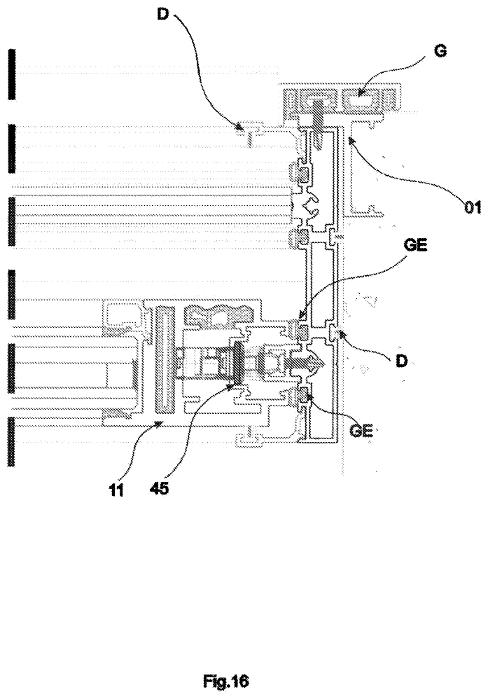

FIG. 17 shows a plan view of the noise-reduction system applied to the junction of leaves (containing brush sealing with felt, trims for acoustics, a specific trim model, a specific profile model and a specific profile junction model);

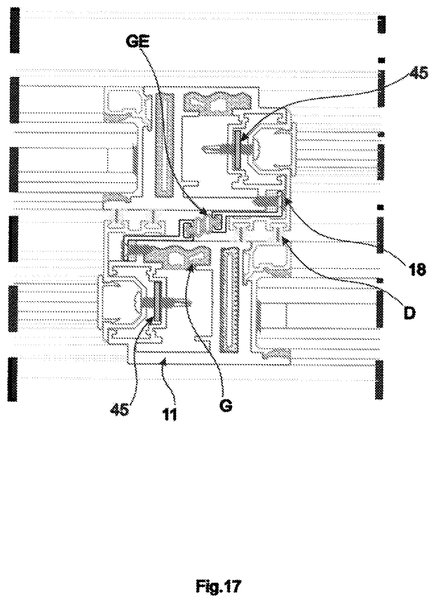

FIG. 18 shows a plan view of the noise-reduction system applied to the junction of half-leaves (containing brush sealing with felt, trims for acoustic reduction, a specific trim model and a specific profile model);

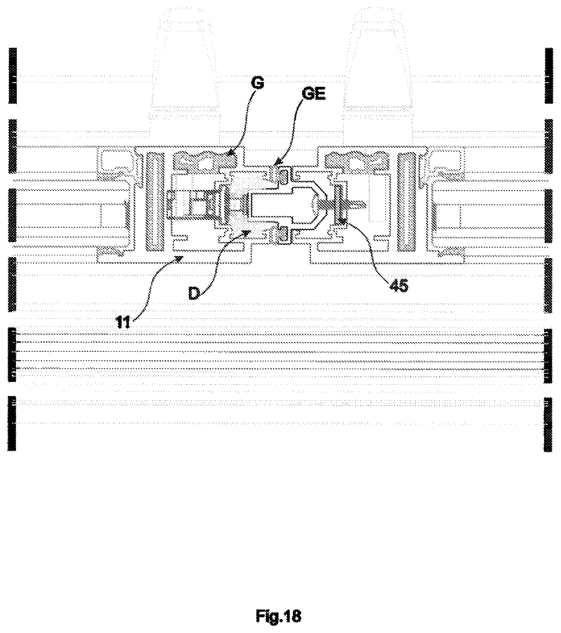

FIG. 19 shows a cross-section of the noise-reduction system applied to the junction of ninety-degree leaves (containing trims for acoustic reduction, a specific trim model, a specific profile model, (element 21) fixed to one leaf allows the fitting of the other leaf with brush and trim for acoustic insulation);

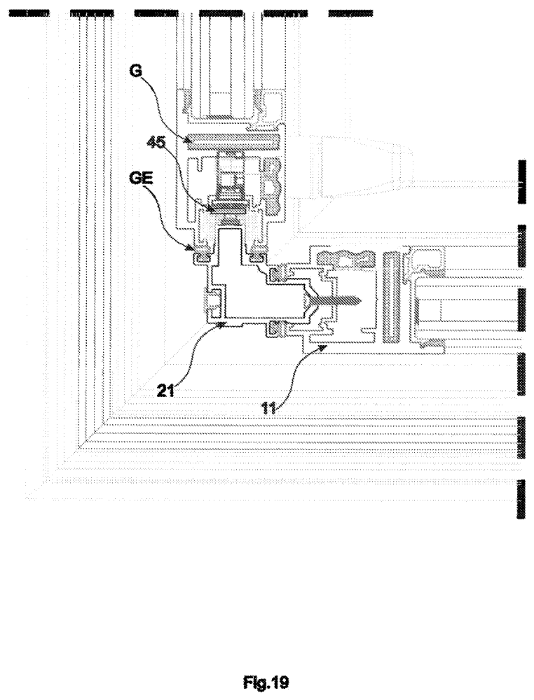

FIG. 20 shows a cross-section of the noise-reduction system applied to two upper planes (containing a seal with a felt brush, a larger frame, trims for acoustic reduction, a specific model of profiles, and a specific model of upper adjustment);

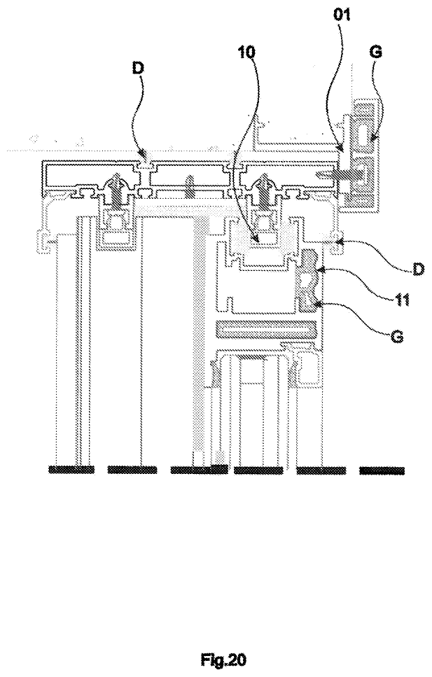

FIG. 21 shows a cross-section of the noise-reduction system applied to two lower planes (containing a seal with a felt brush, a larger frame, trims for acoustic reduction, a specific model of profiles, and a specific model of rail and rail support);

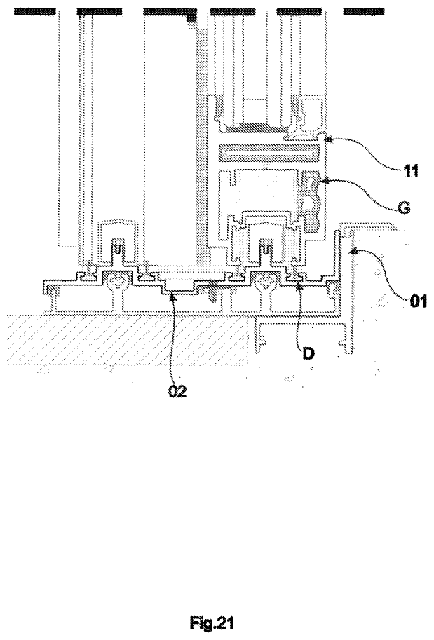

FIG. 22 shows a plan view of the noise-reduction system applied to the profile junction (containing a hand-held profile junction adjustment, trim and brushes with felt);

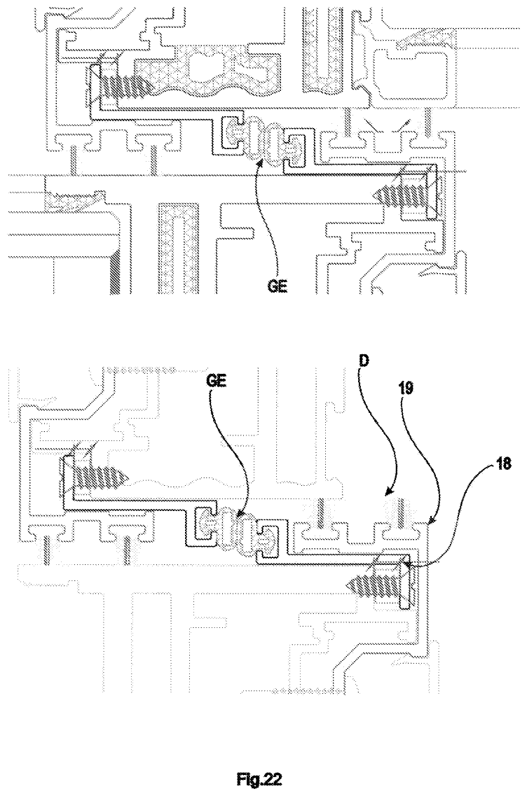

FIG. 23 shows a plan view of the noise-reduction system applied to the upper/upper sliding adjustment (containing an upper profile with measurement adjustment, brush with felt, acoustic insulation and windbreak, frame guide placed after the installation of the frame that enables acoustic sealing);

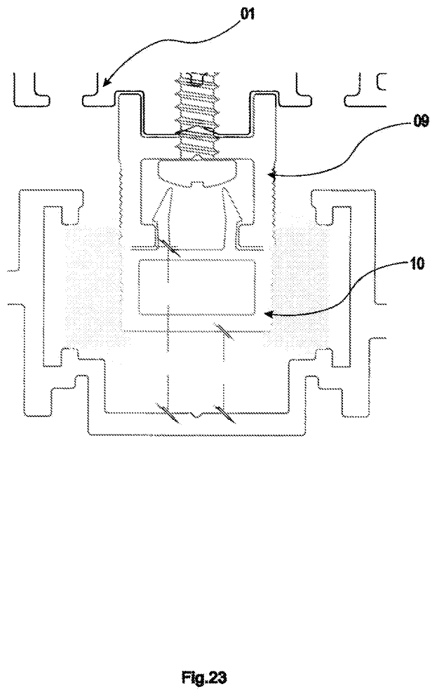

FIG. 24 shows, in cross-section, the anti-noise system applied to the rail and rail support (containing acoustic sealing strips on the pulley guide and damping gaskets for the pulley guide, rail and rail support, acoustic brushes) and (containing rail drilling and support for water drainage);

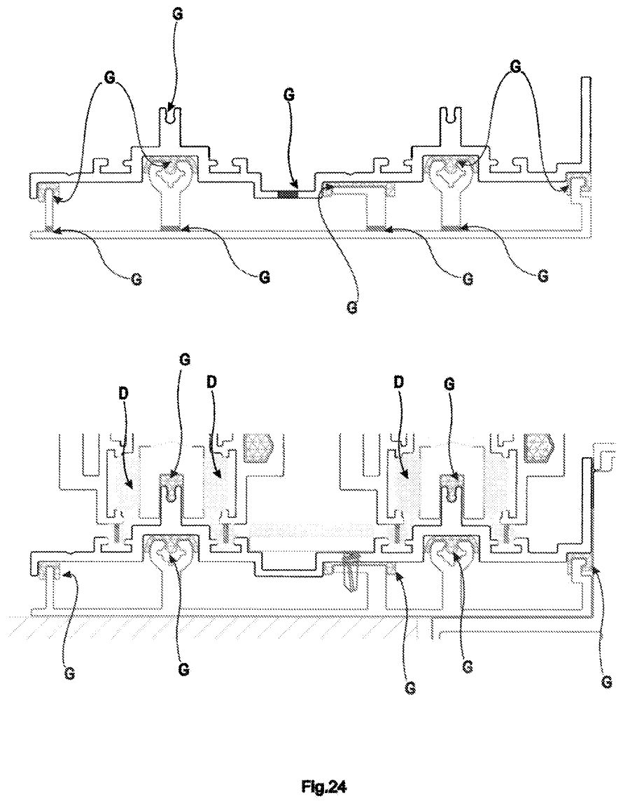

FIG. 25 shows, in plan, the anti-noise system formed in various sealing assembly applications (acoustic, windbreak and cleaning brush);

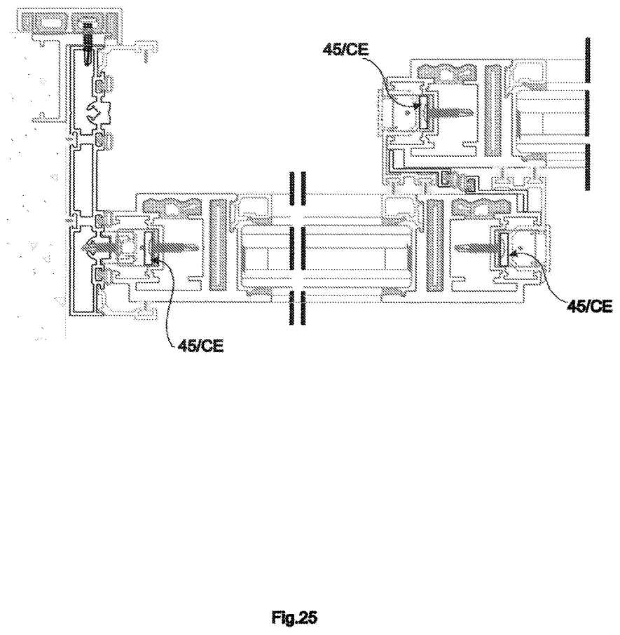

FIG. 26 shows, in cross-section, the anti-noise system formed in the upper application of the sealing assembly;

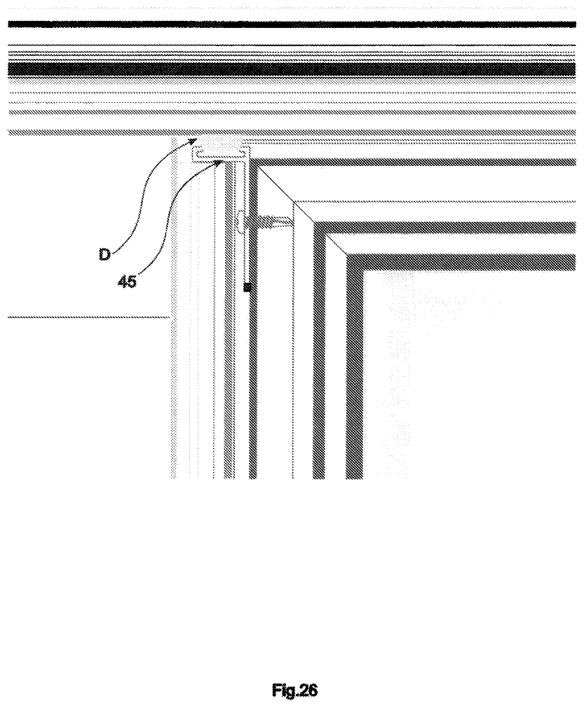

FIG. 27 shows in perspective the noise-reduction system formed in the upper application of the sealing assembly (containing a shim and brush assembly, and a sealing assembly “L” (element 45, with a brush between the sheets);

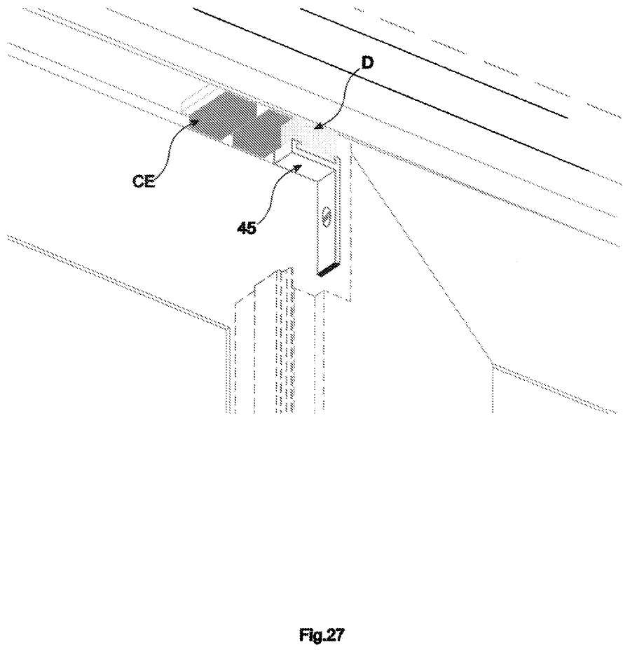

FIG. 28 shows in cross-section the noise-reduction system formed in the lower application of the sealing assembly, which serves to seal and clean the rail (element 45);

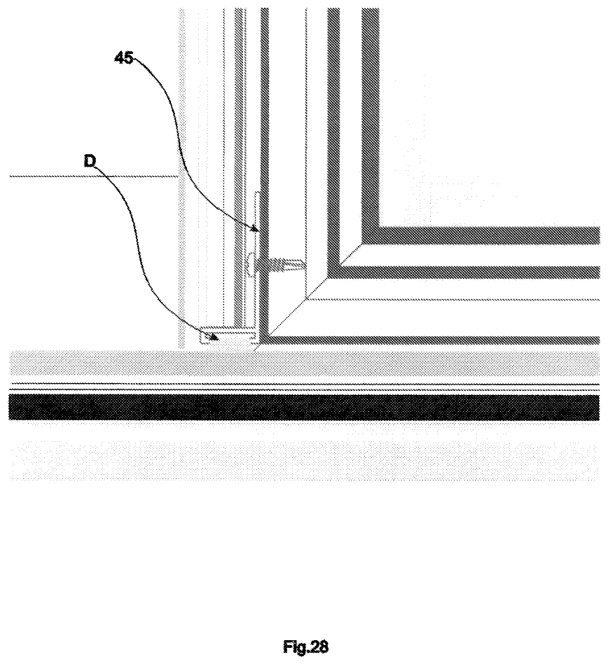

FIG. 29 shows in perspective the noise-reduction system formed in the lower application of the sealing assembly, containing the items a shim and brush assembly, and a sealing assembly (element 45, with a brush between the sheets);

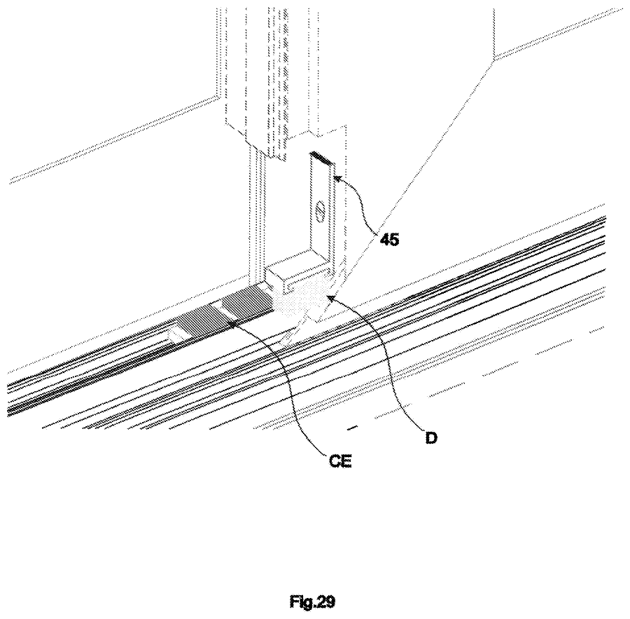

FIG. 30 shows a plan view of the noise-reduction system in expanded sliding assemblies, showing the frame without the three planes;

FIG. 31 shows a plan view of the noise-reduction system in expanded sliding assemblies with three planes;

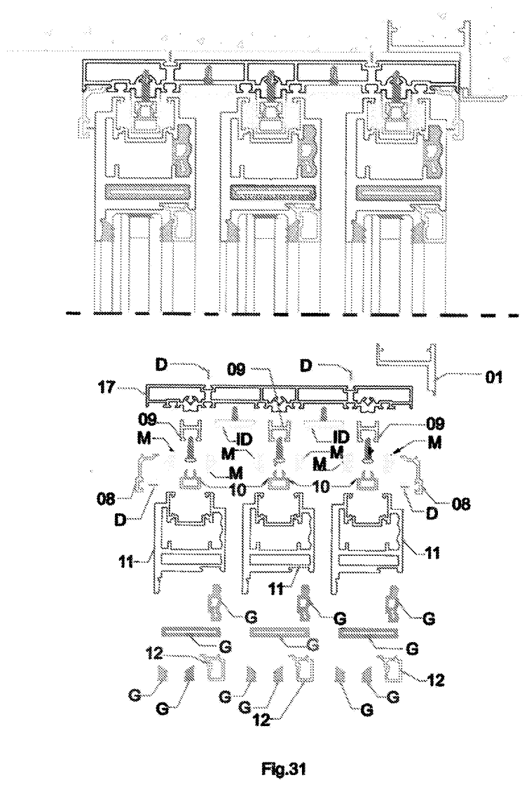

FIG. 32 shows a plan view of the noise-reduction system in expanded sliding assemblies with three planes;

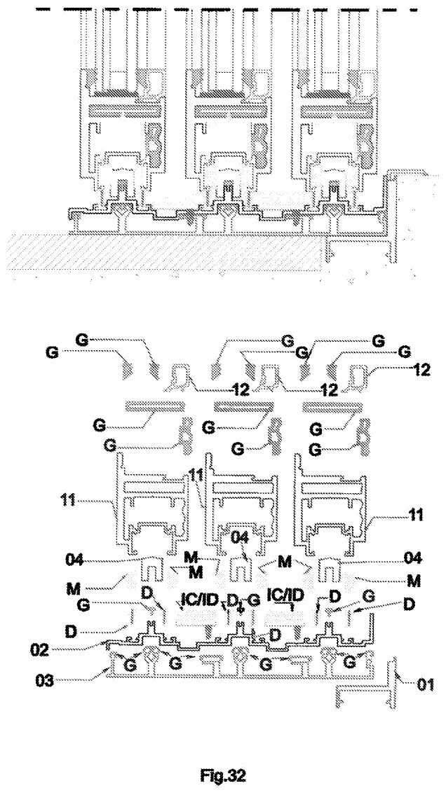

FIG. 33 shows a plan view of the noise-reduction system in expanded sliding assemblies with three planes and implementation of a drain box;

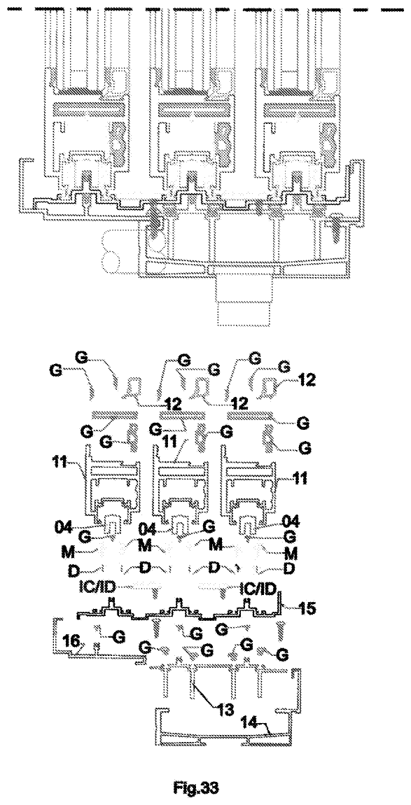

FIG. 34 shows a plan view of the noise-reduction system in expanded sliding assemblies with two planes;

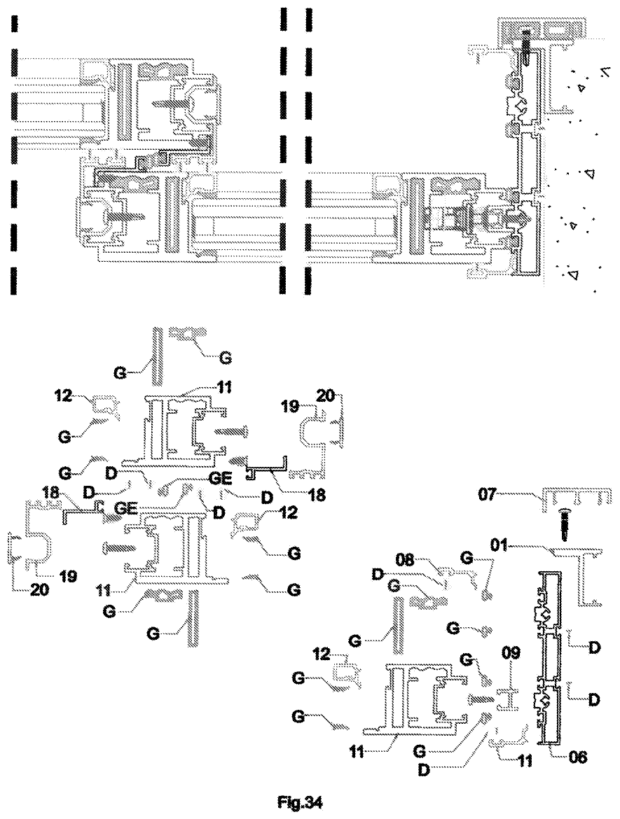

FIG. 35 shows a plan view of the noise-reduction system in expanded sliding assemblies with two planes and implementation of a drain box;

FIG. 36 shows a plan view of the noise-reduction system in expanded assemblies with center-mounted panels;

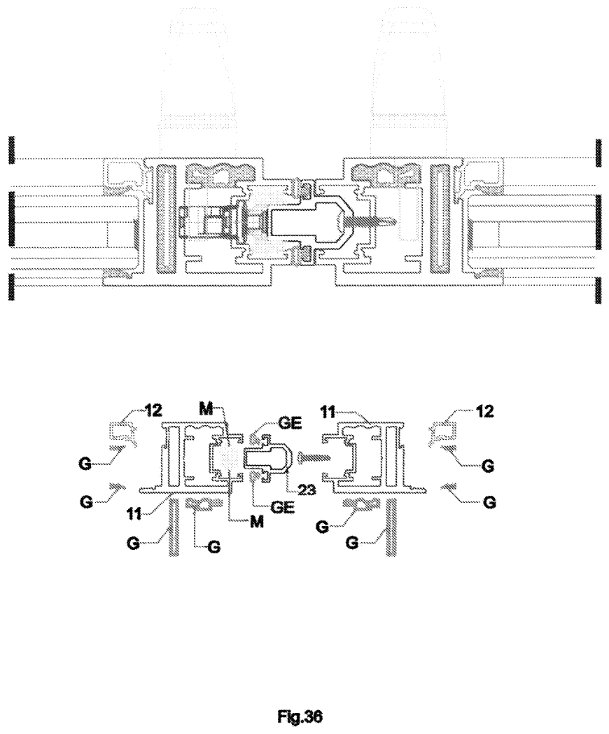

FIG. 37 shows, in plain view, the soundproofing system formed in expanded assemblies with ninety-degree leaf abutments;

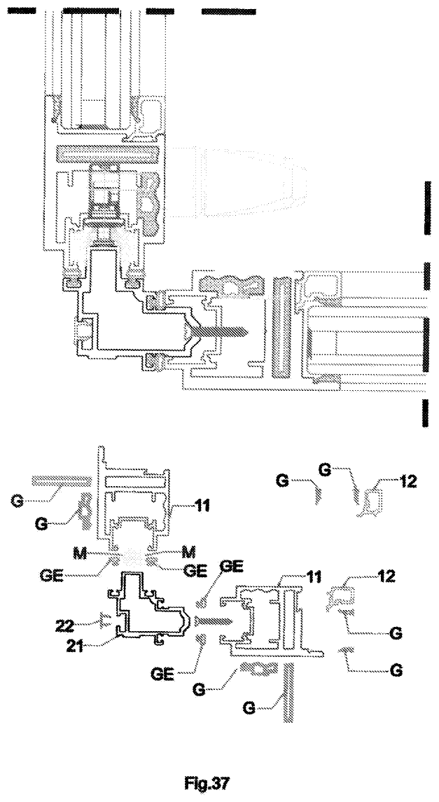

FIG. 38 shows, in cross-section, the soundproofing system formed in two-plane sliding expanded assemblies;

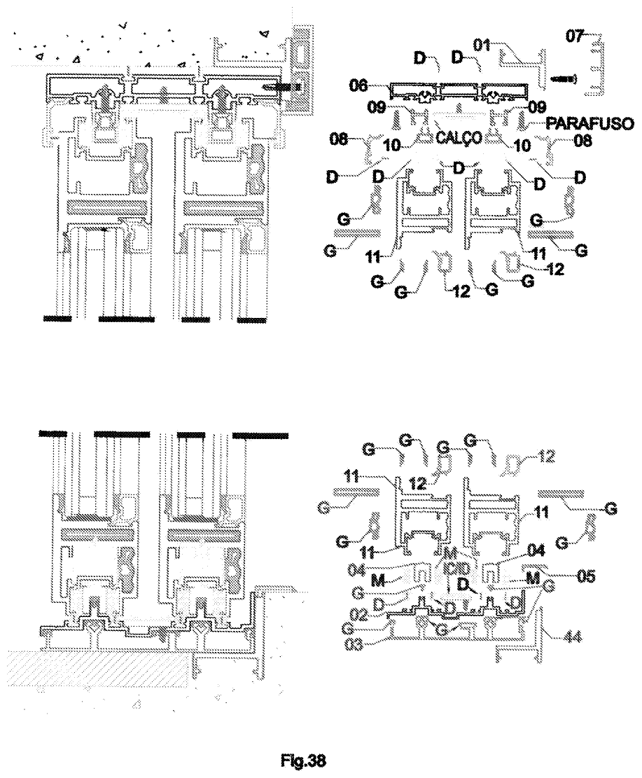

FIG. 39 shows, in cross-section, the soundproofing system formed in fixed-plane expanded assemblies;

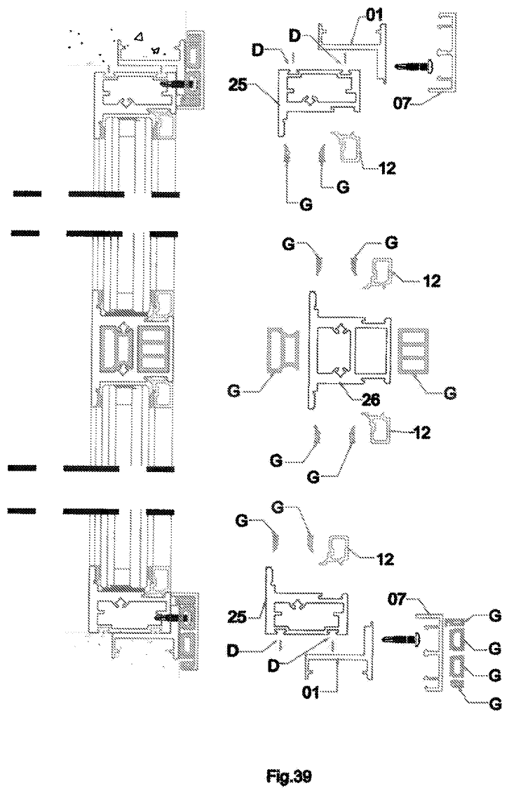

FIG. 40 shows, in cross-section, the soundproofing system formed in fixed-plane expanded assemblies;

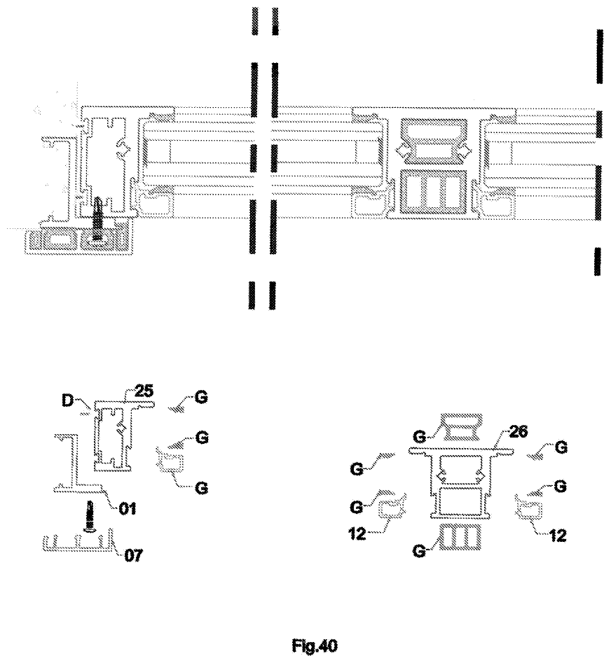

FIG. 41 shows, in plain view, the soundproofing system formed in maximum air expanded assemblies;

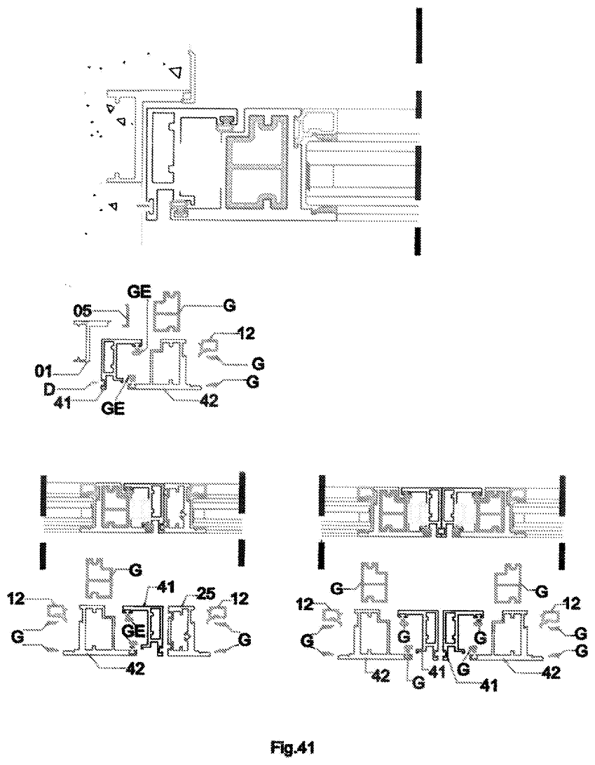

FIG. 42 shows, in cross-section, the soundproofing system formed in maximum air expanded assemblies;

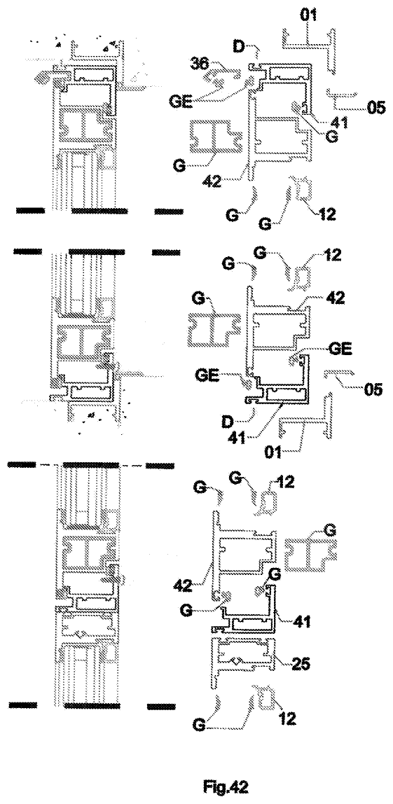

FIG. 43 shows, in cross-section, the soundproofing system formed in swing leaf expanded assemblies, in plain view;

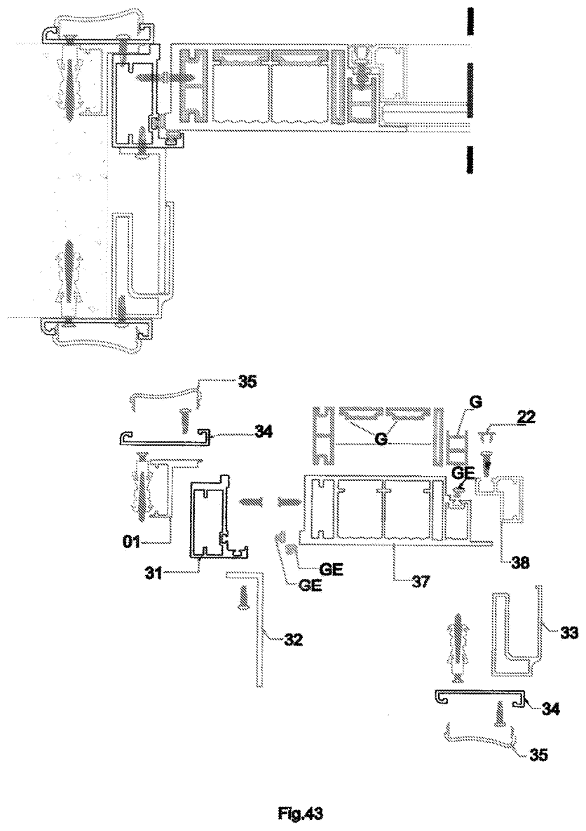

FIG. 44 shows, in cross-section, the soundproofing system formed in swing leaf expanded assemblies, in plain view;

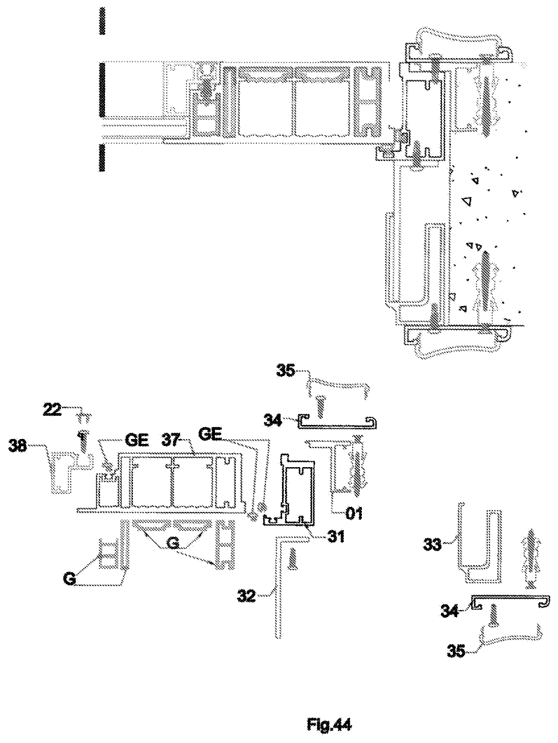

FIG. 45 shows a cross-section of the noise-reduction system formed in expanded swing leaf assemblies;

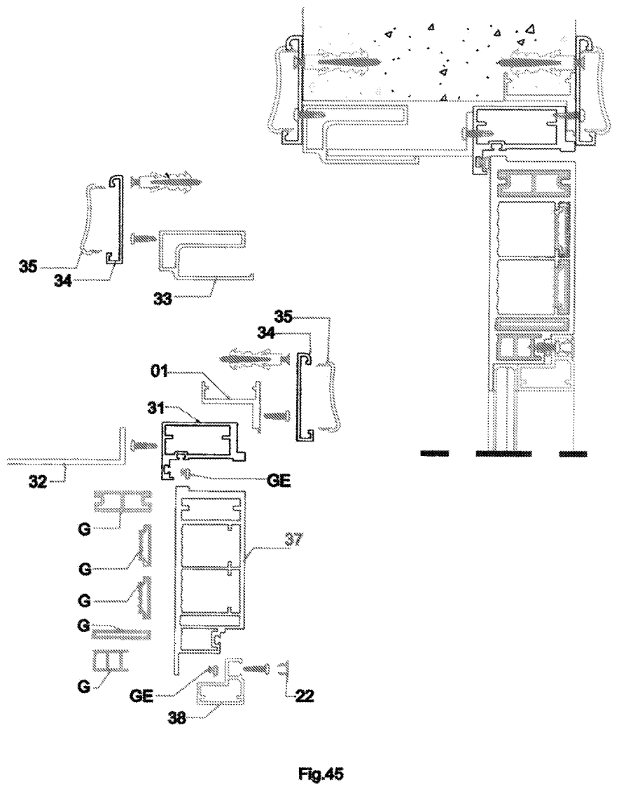

FIG. 46 shows a cross-section of the noise-reduction system formed in expanded swing leaf assemblies;

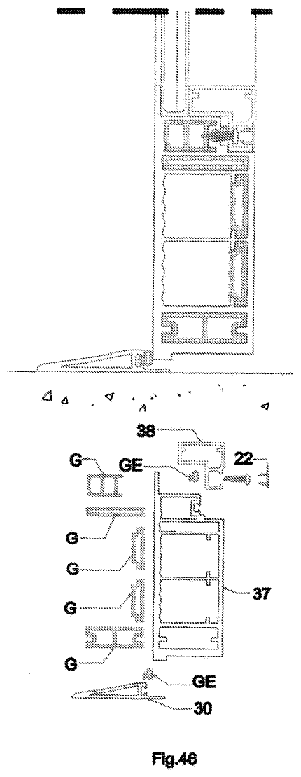

FIG. 47 shows a cross-section of the noise-reduction system formed in structured trim (GE) with cutouts to induce compression shape;

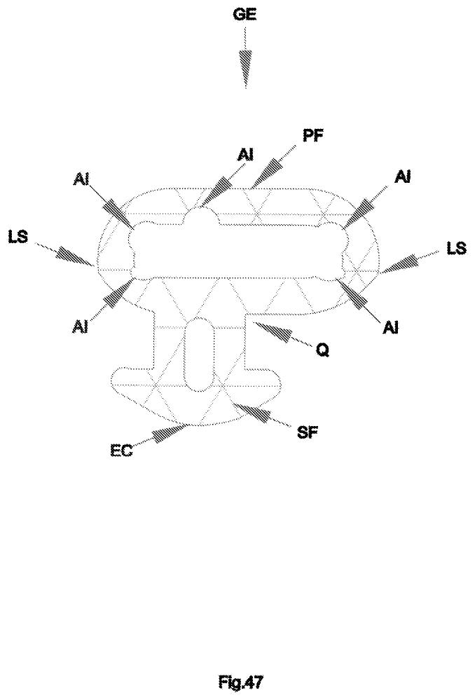

FIG. 48 shows a cross-section of the noise-reduction system formed in profiles and component elements with the following items: counterframe (01), two-plane rail (02), two-plane rail support (03), pulley rail (04), finish (05), two-plane frame (06);

FIG. 49 shows a cross-section of the noise-reduction system made up of profiles and component elements with the following items: trim (07), drip tray (08), frame guide (09), upper leaf seal (10), sliding leaf (11), insulated baguette (12), rail support (13);

FIG. 50 shows a cross-section of the noise-reduction system made up of profiles and component elements with the following items: gutter (14), three-plane rail (15), gutter extension (16);

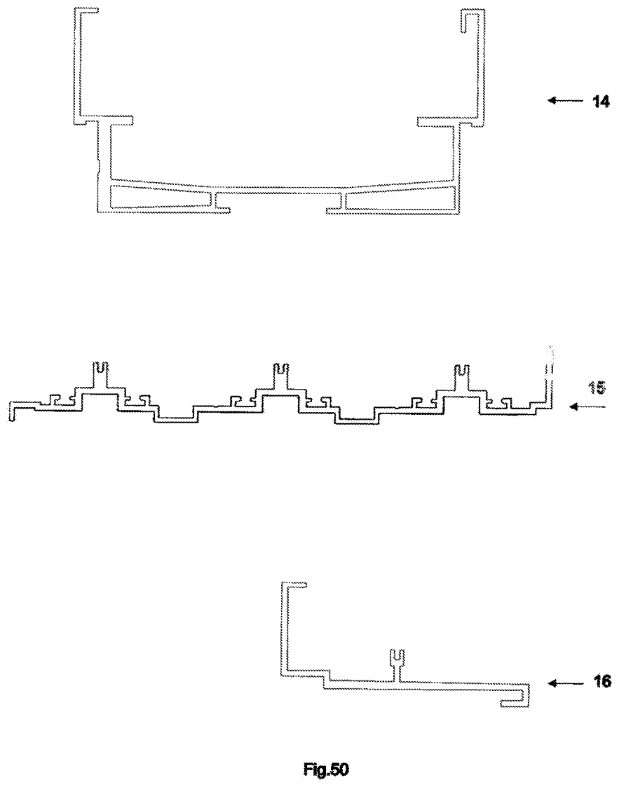

FIG. 51 shows a cross-section of the noise-reduction system made up of profiles and component elements with the following items: three-plane frame (17), adjustment between leaves (18), seal between leaves (19), central sealing cover (20), corner joint (21); corner joint cover (22), central stop (23);

FIG. 52 shows a cross-section of the noise-reduction system made of profiles and component elements with the following items: laminated baguette (24), half-column (25), crosspiece/column (26), corner (27), wedge (28), three-plane rail support (29);

FIG. 53 shows a cross-section of the noise-reduction system made of profiles and component elements with the following items: floor finish (30), pivot frame (31), adjustment corner (32), adjustment frame (33), finish support (34), finish (35), drip tray (36);

FIG. 54 shows a cross-section of the noise-reduction system made of profiles and component elements with the following items: swing leaf (37), laminated baguette (38), insulated baguette (39), sheet baguette (40), maximum air frame (41);

FIG. 55 shows a cross-section of the noise-reduction system made of profiles and component elements with the following items: maximum air leaf (42), gutter cover (43), counterframe (44), seal between leaves (45), wedge (46);

FIG. 56 shows a cross-section of the noise-reduction system made of profiles with greater mass and undulation for acoustic obstruction.

In accordance with the figures above, the invention consists of an assembly process and modalities in construction arrangements based on the composition of component profile elements and accessories, being counterframe (01), two-plane rail (02), two-plane rail support (03), roller rail (04), finish (05), two-plane frame (06); finish (07), drip pan (08), frame guide (09), upper leaf seal (10), sliding leaf (11), insulated baguette (12), rail support (13); gutter (14), three-plane rail (15), gutter extension (16); three-plane frame (17), adjustment between leaves (18), seal between leaves (19), central seal cover (20), corner joint (21); corner joint cover(22), central stop(23); laminated baguette(24), half column(25), crosspiece/column(26), angle(27), wedge(28), three-plane rail support(29); floor finish(30), pivot frame(31), adjustment angle(32), adjustment frame(33), finish support(34), finish(35), drip pan(36); pivot leaf(37), laminated baguette(38), insulated baguette(39), sheet baguette(40), maximum air frame(41); maximum air leaf(42), gutter cover(43), counterframe(44), seal between leaves(45) shim/brush(CE), shim(46); being that in construction arrangements in composition with anti-noise broom sealing (D), counterframe with thickened thickness (RA), structured trims (GE) for acoustics are combined in arrangements with profiles and profile meeting, upper adjustment by means of frame guide device (09) in opening of the frame two planes (06) in which it will be aligned flush to reduce gaps and the plane positioned;

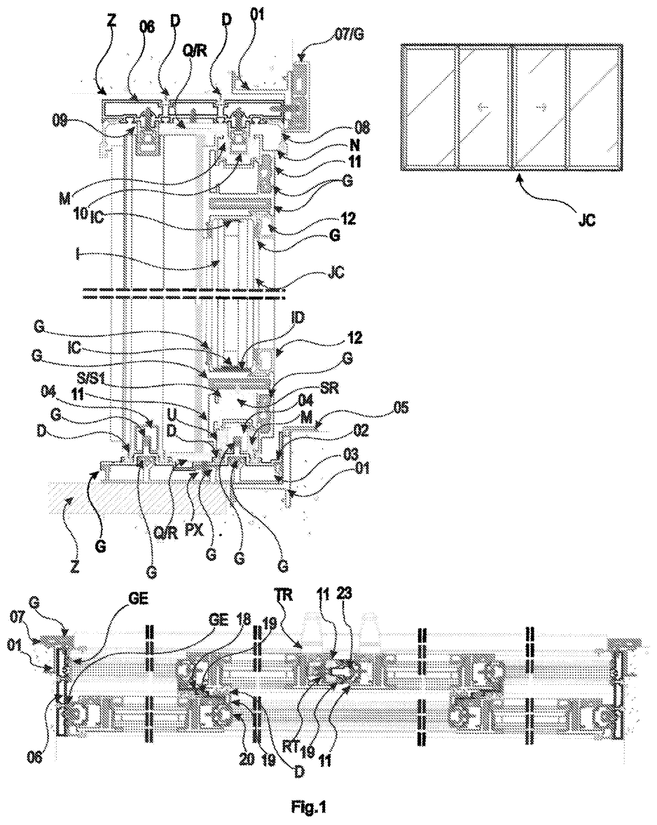

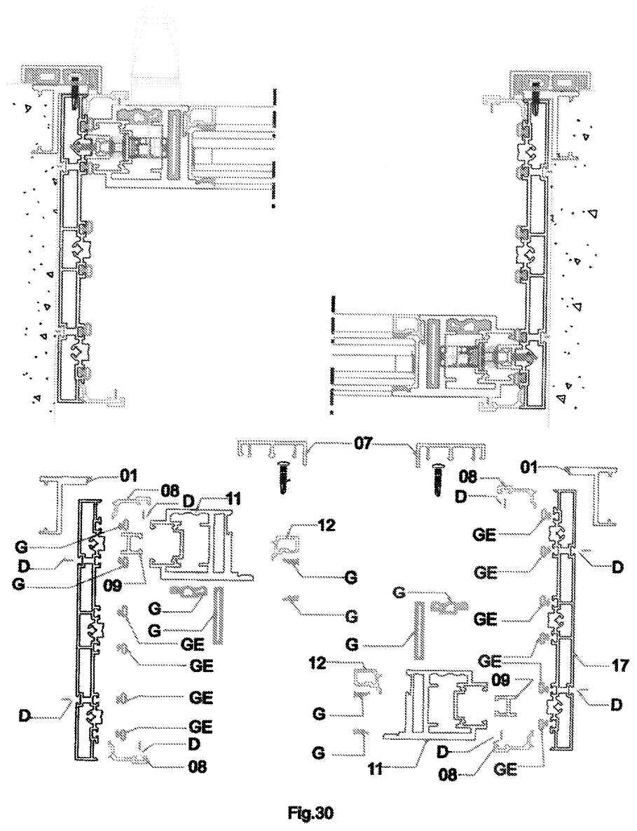

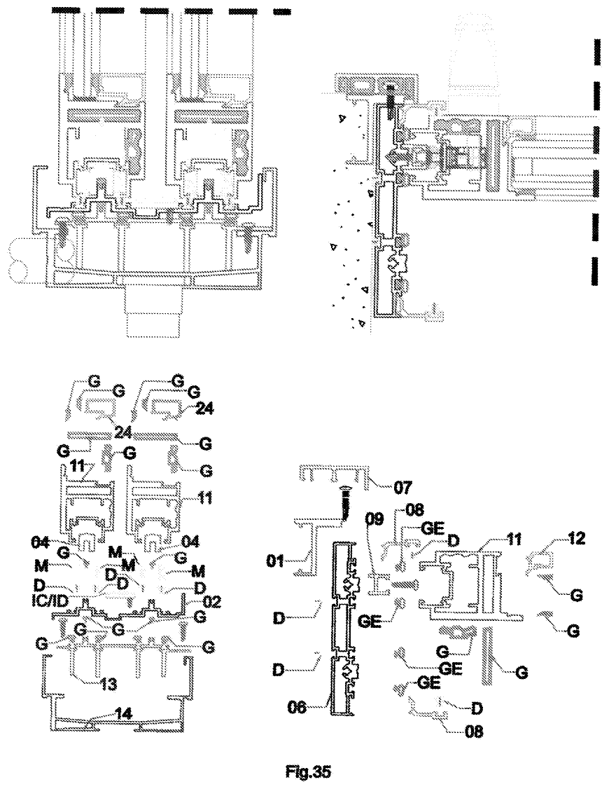

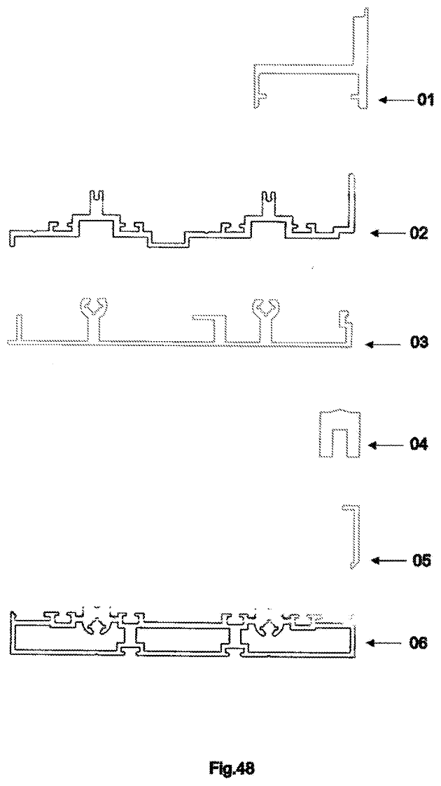

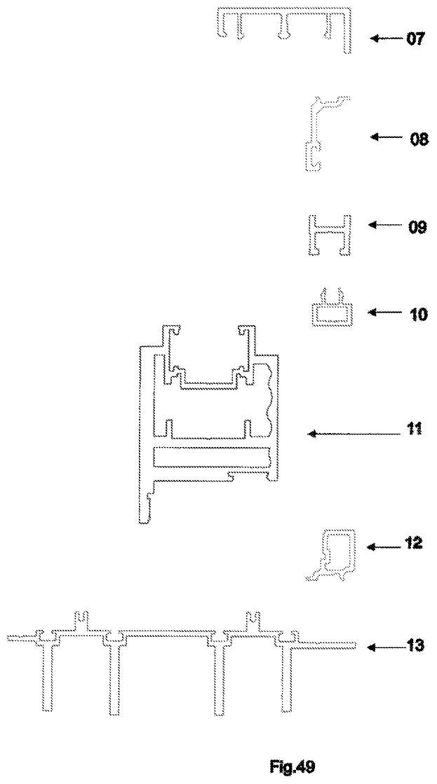

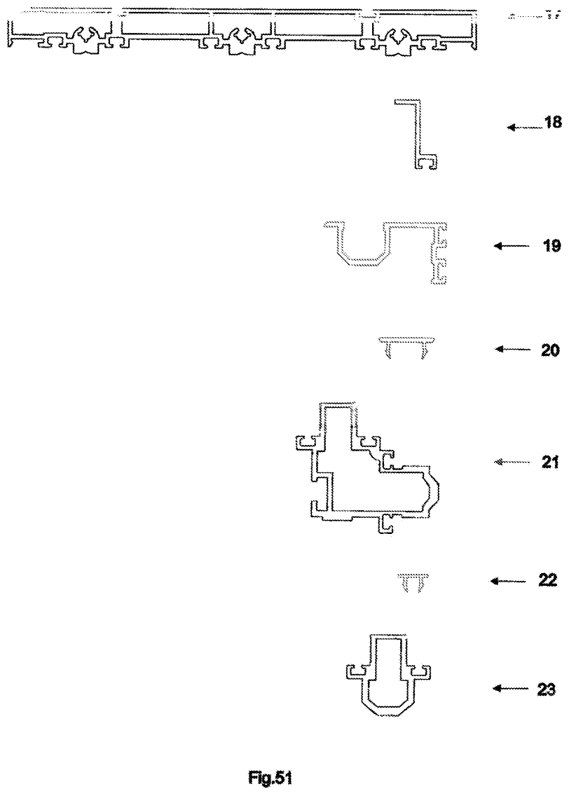

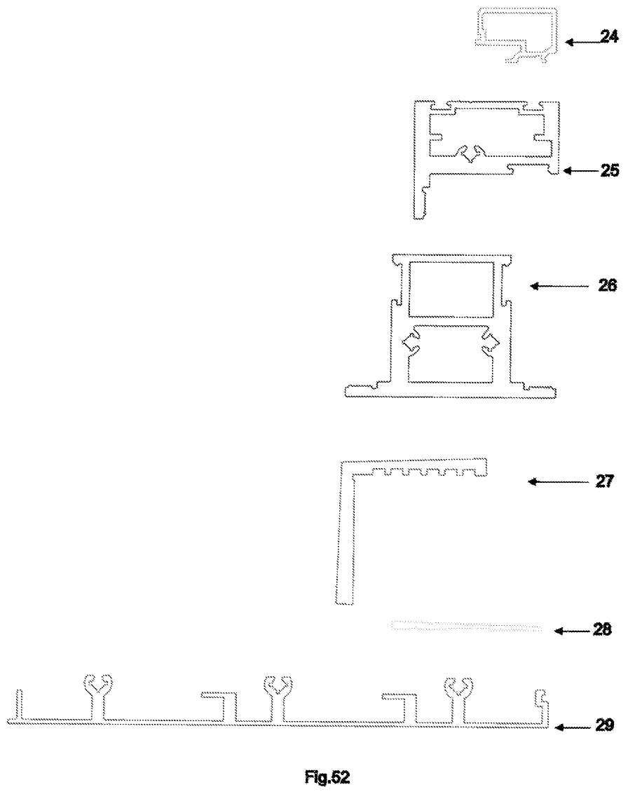

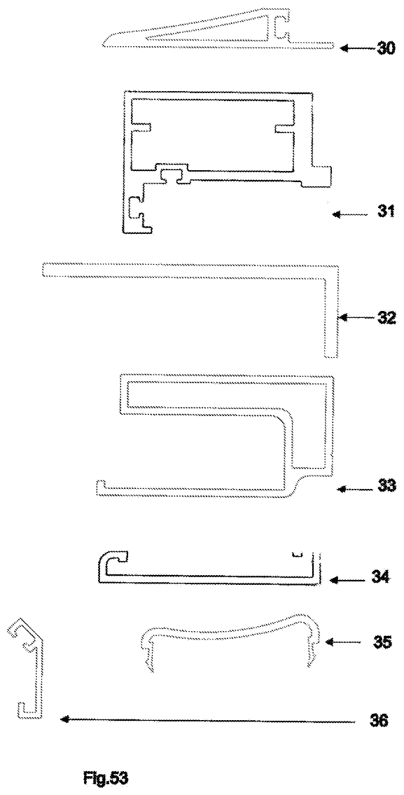

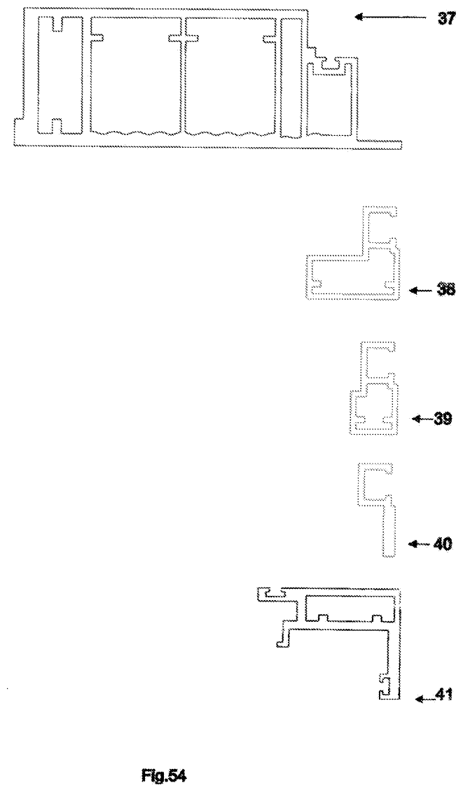

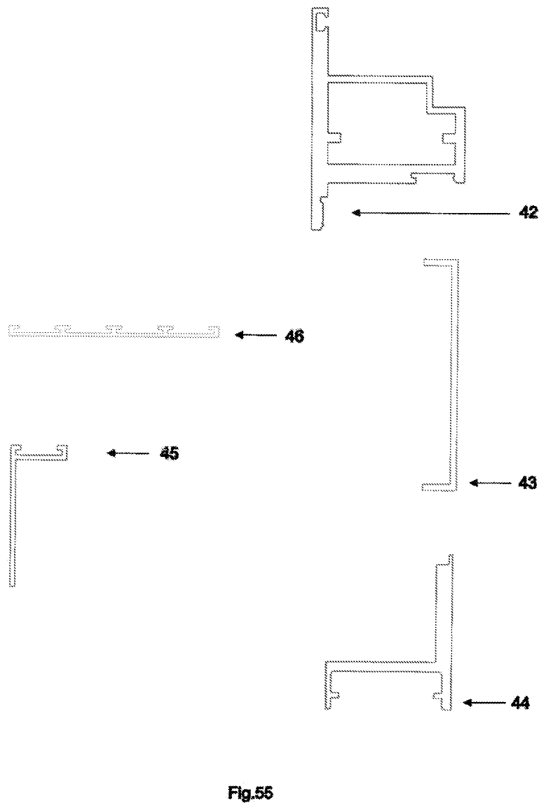

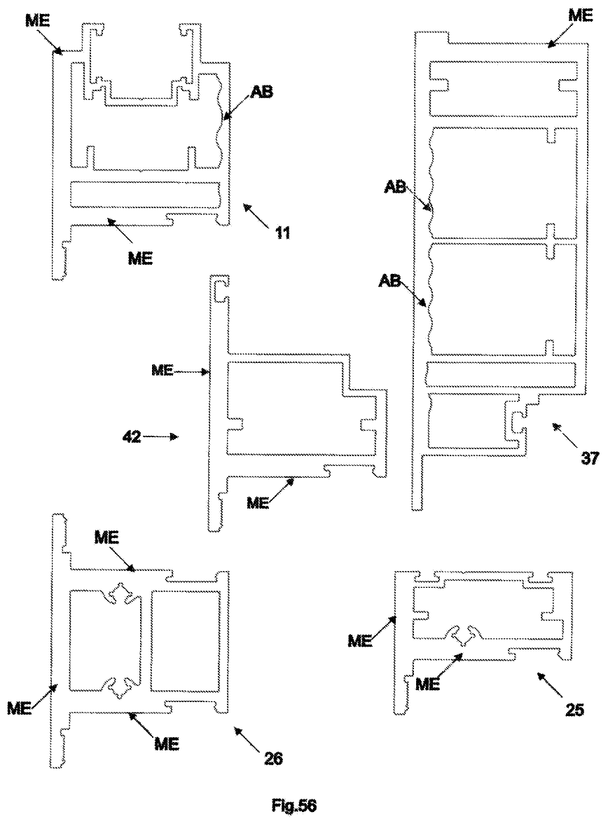

In mode 1—two-plane, four-leaf sliding door (JC) (FIG. 1), there is a composition of the brush sealing element with anti-noise and wind felt (D), with the thickened counterframe element (RA), with the structured trim element (GE) for acoustics, they are combined in arrangements with the profile element and profile meeting, upper adjustment by means of the frame guide element (09) in the opening of the two-plane frame element (06), in which it will be aligned flush to reduce the gap and the plane positioned so that mode 1—two-plane, four-leaf sliding door (JC) is formatted at its ends of each plane by the connection with the sliding leaf profile element (11), with mode 1 formed in the upper part by the two-plane frame element (06) with the two-plane frame element (06) on the left side and right side of the work span (Z), which form the left and right jambs and connect the two-plane frame element (06) that forms the base, and below, positioned the three-plane rail element (15) which is supported by the rail support element (13) supported on the gutter element (14), with the gutter extension element (16) for waste outlet (SR); and frame guide element (09) placed after the three-plane frame element (17) or two-plane frame element (06), for drilling the two-plane rail support element (02) or three-plane rail support (29) for water drainage through the gutter element (14), with the extension of the gutter element (14) having the function of expanding collection; so that the shim element (46) and the brush element (ID/IC) make up the sealing set of brushes between sheets for sealing; so that the guide frame element (09) in the opening of the frame element two planes (06) in which it will be aligned flush to reduce the gap and positioned the plane of mode 1—sliding door with two planes and four leaves (JC), formed internally by glass element (I) attached and sealed by insulated baguette trim element (G) with internal insulation by broom baguette element (IC/ID), and at the top, by the sliding sheet profile element (11) with greater mass and undulation for acoustic containment, and which has internal channels for the trim element (G), and in the upper opening attached to the frame guide element (09) a top sheet sealing baguette element (10) is fitted with lateral sealing by broom baguette element (M), being that mode 1 two-plane, four-leaf sliding door (JC) fixed to the counterframe element (01) existing in the work opening (Z) in which it is fixed by means of a transverse screw in the two-plane frame element (06) which has in channels, the anti-noise broom element (D) for sealing flush with the work opening (Z), then it is fixed by means of a screw, in the frame guide element (09) in the opening of the two-plane frame element (06) in which it will be aligned flush to reduce the gap and positioned in the flat element of the door two-plane, four-leaf running (JC), formed internally by glass (I) attached and sealed by the insulated baguette element (12) and the trim element (G) with internal insulation in the broom baguette element (IC/ID), and at the top, by the running sheet profile element (11) with greater mass and undulation for acoustic containment, and which has internal channels for the trim element (G), and in the upper opening attached to the frame guide element (09) a sealing baguette element upper sheet (10) is fitted with lateral sealing in the baguette element with brooms (M), with a seal on the edge of the running sheet profile element (11) in the baguette element with brooms (N) fitted into the device in the dripping element (08) and fitted into the two-plane frame element (06) and juxtaposed in the finishing profile element (07), which has internal sealing channels for the trim element (G); existing between units of mode 1 two-plane, four-leaf sliding door (JC), the widened baguette broom element (Q) together with the widened rubber sealing element (R) which also serves as a side seal for the units of the frame guide element (09); so that in the lower part of mode 1—two-plane, four-leaf sliding door (JC), the base of the glass (I) is seated in the broom baguette element (IC/ID) with sealing by the trim element (G), the plane being supported by the sliding leaf profile element (11), which has an internal channel for the trim element (G) and which at the base internally accommodates a receptacle element(S) attached by the screw element (S1) and accommodates a pulley element (SR) which slides over the pulley rail element (04) whose sides have sealing by contact with baguettes of the broom element (V) fitted into the channels (U) of the sliding leaf profile element (11), and the noise-reducing broom element (D) fitted into the two-plane rail element (02), which is supported by the two-plane rail support element (03), joined to the clip element (PX) and sealed by the trim element (G), and which is limited by the counterframe element (01) existing in the work span (Z) and in the finishing element (05); so that mode 1—two-plane, four-leaf sliding door (JC) is formatted at its ends of each plane of the plane by connecting units of the sliding leaf profile element (11), the set being formed in the upper part by the two-plane frame element (06) of the left side and right side of the work span (Z), which form the left and right jambs and connect the two-plane frame element (06) that forms the base; being screwed to the upper and lower sides of the internal and not visible sliding leaf profile units (11), the vertical sealing element (45) that serves to seal the gaps against the passage of wind, dust and sound, helping to reduce noise by compensating for the gap in the upper and lower part of the rails, in cleaning the two-plane rail element (02), upper or lower three-plane rail (15) through the use of the brush wedge element (CE) conferring greater durability to the pulley rail element (04); considering that the increase in thickness (ME), mass and undulation (AB) in profiles with internal application of rubber (G), to obstruct the entry of wind, dust and sound and their dissipation and reverberation, enhancing the effects of the reduction of the gap; the increase in thickness (ME) in profiles with greater mass for acoustic obstruction represented in FIG. 49, sliding leaf element (11); FIG. 54, turning leaf element (37), type of profiles with greater mass for acoustic obstruction represented in FIG. 56, the sliding leaf element (11), the half-column element (25), the turning leaf element (37), the crossbar/column element (26), the maximum air leaf element (42); FIG. 48 shows the counterframe element (01) and the pulley rail element (04); FIG. 51 shows the corner joint element (21), FIG. 52 shows the half-column element (25) and the crossbar/column element (26); FIG. 53 shows the pivot frame element (31); FIG. 54 shows the pivot sheet element (37) and max-ar frame element (41); FIG. 55 shows the max-ar sheet element (42) and counterframe element (44); being that the upper fixation by separation between the frame guide element (09) and the upper sheet sealing element (10) applied in the frame element (17) of three planes and in the frame element (6) of two planes resulted in the minimum reduction of tenths of a millimeter, which is still obstructed by the anti-noise brush component element (D), so that when the fixation by screwing process was implemented in two parts, the two-plane rail profile elements (02) and two-plane rail support elements (03) were also separated into two distinct parts which have, combined with each other, insulation in the contacts by means of the component elements trims (G), which excluded any remaining vibration which interrupted the reverberation of the glass, even the friction of movement of the work disappeared with the process of division of the component elements two-plane rail profiles (02) and two-plane rail support elements (03), as can be seen in FIGS. 30 and 35 and in detail on page 24, in the division of the two-plane rail elements (02), two-plane rail support elements plans(03) as well as in the connection that occurs between the maximum frame profile elements air(41) and maximum leaf elements air(42) with elements the counterframe(01); so that mode 1—two-plane, four-leaf sliding door(JC) is formatted at its ends of each plane by the connection of the sliding leaf profile(11) being the set formed in the part upper by the two-plane frame (06) with the two-plane frame (06) of the left side and right side of the work opening (Z), which form the left and right jambs and connect the two-plane frame (06) that forms the base, and below, positioned the three-plane rail (15) is supported by the rail support (13) resting on the gutter (14) there is the extension of the gutter (16) for waste outlet (SR); being the adoption of the device called “helping hand” for meeting leaves, which has as a differentiation a shim for vertical adjustment, to compensate for eventual irregularities in the plumb lines of the construction opening where the French window or door will be inserted. The perfect adaptation of the rubber gasket, which due to the closing of the French window or door when pressed on the face of the vertical jamb and promotes the sealing in a wide and homogeneous way; laminated baguette (38), insulated baguette (39) and sheet baguette (40) components are still used, which provide greater pressure, increasing acoustic insulation because they are screwed and not just fitted, which over time and use generates slack and new noises. The previously existing system used in doors and belonging to the state of the art, was focused on the pressure baguette with fitting with the unique possibility of increasing the thickness of the rubber, which in addition to the structured trim element (GE) configures a corner joint profile element (21) which moves together with the leaf, forming an aesthetically symmetrical element on both sides. This vertical profile element (11) is configured as a corner, being fixed to one of the leaves that fits into the other leaf that moves towards it. In addition to thickened thickness and containing structured trim (GE);

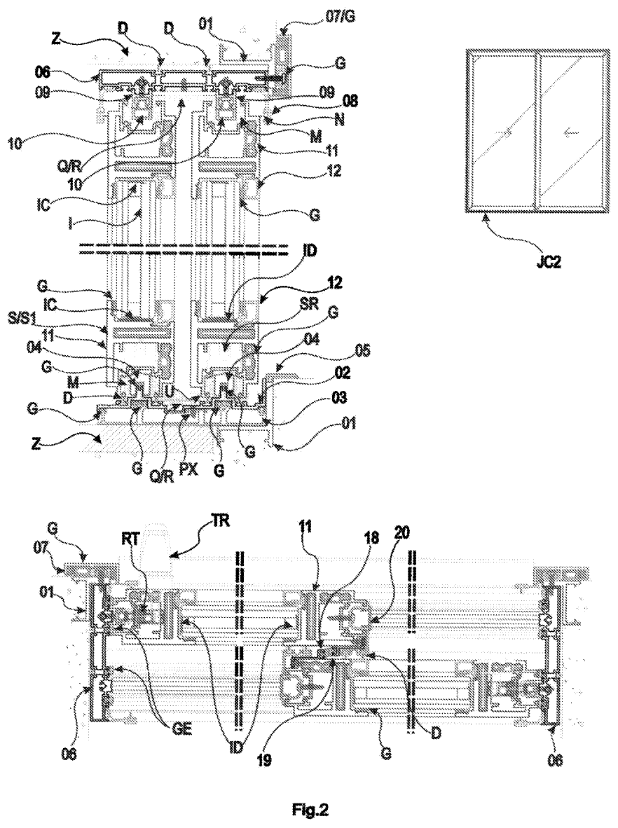

So that in FIG. 2 mode 2—in the sliding door with two planes and two leaves (JC2); fixed to the subframe (01) existing in the work opening (Z) in which it is fixed by means of a screw to the two-plane frame (06) which has anti-noise brooms (D) fitted in channels for sealing flush with the work opening (Z), then the frame guide device (09) is fixed by means of a screw in the existing opening in the two-plane frame (06) in which it will be aligned flush to reduce the gap, and the plane of the two-plane, four-leaf sliding door (JC) is positioned, consisting of glass (I) secured and sealed by insulated baguette (12) and trim (G) with internal insulation by broom baguette (IC/ID) and by the sliding leaf profile (11) with greater mass and undulation for acoustic containment, and which has internal channels for trim (G), and in the upper opening a top leaf sealing baguette (10) with side sealing by baguette with brooms (M) is fitted to the frame guide device (09), there being on the edge of the sliding leaf profile (11) a baguette seal with brooms (N) fitted into the drip device (08) and fitted into the two-plane frame (06) and juxtaposed the finishing profile (07), which has internal sealing channels for the trim (G); there being between the two-plane, four-leaf sliding door units (JC), an enlarged baguette broom (Q) next to the enlarged sealing rubber (R) which also serves as a side seal for the frame guide device units (09); so that in the central part of the two-plane, four-leaf sliding door (JC) at the crossing of each plane and at the end of the path there will be structured trim units (GE) formatted in moldable structured rubber under pressure to actuate the latches (TR) which move to lock in each plane of mode 2—in the two-plane, two-leaf sliding door (JC2); and when sliding two planes in the same direction, one plane may be connected to another by means of the inter-leaf adjustment device (18) “helping hand” construction arrangement fixed by a screw at the vertical top hidden by an inter-leaf sealing device (19) with anti-noise brooms (D) and secured by a screw and central sealing cap (20), having inserted in the inter-leaf adjustment device (18) more structured trim units (GE) formatted in moldable structural rubber between themselves under pressure to actuate the latches (TR) moving the device (RT) housed in the ends of the sliding leaf profile (11) of each unit of the door plane; so that in the lower part of mode 2—in the two-plane, two-leaf sliding door (JC2), the base of the glass (I) are seated on a base (ID) sealed by a trim (G), supported on the sliding leaf profile (11), which has an internal channel for the trim (G) that internally accommodates a receptacle (S) secured by a screw (S1) and accommodates a pulley (SR) which slides on a pulley rail (04) whose sides are sealed by contact with broom-type baguettes (V) fitted into the channels (U) of the sliding leaf profile (11) and anti-noise brooms (D) fitted into the two-plane rail (02), which is supported on the two-plane rail support (03), joined by a clip (PX) and sealed by trim (G), and which is limited by the counterframe (01) existing in the span of the work (Z) and finish (05) which internally has sealing channels for the trim (G); being screwed to the upper and lower sides of the internal and non-visible sliding leaf profile units (11), the vertical sealing element (45) with a coupled shim/brush element (CE) that serves to seal the gaps against the passage of wind, dust and sound, helping to reduce noise by compensating for the gap in the upper and lower part of the rails, in cleaning the two-plane rail element (02), upper or lower three-plane rail (15) from the use of the shim/brush element (CE) conferring greater durability to the pulley rail element (04); considering that the increase in thickness (ME), mass and undulation (AB) in profiles with internal application of rubbers (G), to obstruct the entry of wind, dust and sound and their dissipation and reverberation, enhancing the effects of the gap reduction; the increase in thickness (ME) in profiles with greater mass for acoustic obstruction represented in FIG. 49 sliding leaf element (11); FIG. 54 swing leaf element (37), type of profiles with greater mass for acoustic obstruction represented in FIG. 56, the sliding leaf element (11), the half-column element (25), the swing leaf element (37), the crossbar/column element (26), the maximum air leaf element (42); FIG. 48 shows the counterframe element (01) and the pulley rail element (04); FIG. 51 shows the corner union element (21); FIG. 52 shows the half-column element (25) and the crossbar/column element (26); FIG. 53 shows the swing frame element (31); FIG. 54 shows the swing leaf element (37) and the max-air frame element (41); FIG. 55 shows the maxi-air leaf element (42) and the counterframe element (44); being that the upper fixation by separation between the frame guide element (09) and the upper sheet sealing element (10) applied in the frame element (17) of three planes and in the frame element (6) of two planes resulted in the minimum reduction of tenths of a millimeter, which is still obstructed by the brush component element (D), so that when the fixation by screwing process was implemented in two parts, the two-plane rail profile elements (02) and two-plane rail support elements (03) were also separated into two distinct parts which have, combined with each other, insulation in the contacts by means of the component elements trims (G), which excluded any remaining vibration which interrupted the reverberation of the glass, even the friction of movement of the work disappeared with the process of division of the component elements two-plane rail profiles (02) and two-plane rail support elements (03), as can be seen in FIGS. 30 and 35 and in detail on page 24, in the division of the two-plane rail elements (02), two-plane rail support elements (03) both as in the connection that occurs between the maximum frame profile elements (41) and maximum leaf elements (42) with the counterframe elements (01); being the adoption of the device called “helping hand” for the meeting of leaves, which has as a differentiation a shim for vertical adjustment, to compensate for eventual irregularities in the plumb lines of the construction span where the French window or door will be inserted. The perfect adaptation of the rubber gasket, which due to the closing of the French window or door when pressed on the face of the vertical frame and promotes the sealing in a broad and homogeneous way; still using component elements laminated baguette (38), insulated baguette (39) and sheet baguette (40) which provides greater pressure, increasing the acoustic insulation because it is screwed and not just fitted which over time and use, generates slack and new noises. The previously existing system used in doors and belonging to the state of the art, was focused on the pressure baguette with fitting with a unique possibility of increase in the thickness of the rubber, which in addition to the structured trim element (GE) configures a corner joint profile element (21) which moves together with the sheet, forming an aesthetically symmetrical element on both sides. This vertical profile element (11) is configured as a corner element, being fixed to one of the sheets that fits into the other sheet that moves towards it. In addition to thickened thickness and containing structured trim (GE);

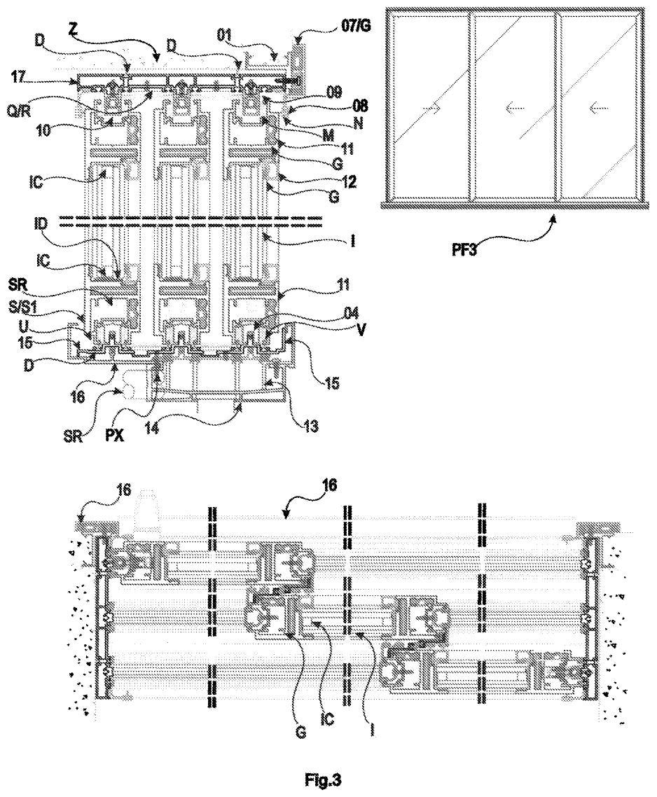

So in mode 3—three-plane, three-leaf sliding door (PF3) (FIG. 3) fixed to the subframe (01) existing in the work space (Z) in which it is fixed by means of a screw in a three-plane frame (17) which has anti-noise brooms (D) fitted in the channels flush with the existing gap in the work (Z), then the frame guide device (09) is fixed by means of a screw in the opening of the three-plane frame (17) in which it will be aligned to reduce the gap, and the plane of the three-plane, three-leaf sliding door (PF3) is positioned, formed internally by glass (I) attached and sealed by insulated baguette (12) and trim (G) with internal insulation by broom baguette (IC/ID), and at the top of the frame by the sliding leaf profile (11) with greater mass and undulation for acoustic containment and which has internal channels for trim (G) and in the upper opening attached to the guide device frame (09) a sealing baguette is fitted to the upper sheet (10) with side sealing by baguette with linear brooms (M), with a sealing on the edge of the profile (11) by baguette with linear brooms (N) fitted to the drip device (08) and the finishing profile (07) being juxtaposed, which has internal channels for trim (G) for sealing; with an enlarged baguette broom (Q) between the two-plane, four-leaf sliding door units (JC) together with an enlarged sealing rubber (R) which also serves as side sealing for the frame guide device units (09); positioning on the sides of the gap in the work (Z); being screwed to the upper and lower sides of the internal and non-visible sliding leaf profile units (11), the vertical sealing element (45) with a coupled shim/brush element (CE) that serves to seal the gaps against the passage of wind, dust and sound, helping to reduce noise by compensating for the gap in the upper and lower part of the rails, in cleaning the two-plane rail element (02), upper or lower three-plane rail (15) from the use of the shim/brush element (CE) conferring greater durability to the pulley rail element (04); considering that the increase in thickness (ME), mass and undulation (AB) in profiles with internal application of rubbers (G), to obstruct the entry of wind, dust and sound and their dissipation and reverberation, enhancing the effects of the gap reduction; the increase in thickness (ME) in profiles with greater mass for acoustic obstruction represented in FIG. 49 sliding leaf element (11); FIG. 54 swing leaf element (37), type of profiles with greater mass for acoustic obstruction represented in FIG. 56, the sliding leaf element (11), the half-column element (25), the swing leaf element (37), the crossbar/column element (26), the maximum air leaf element (42); FIG. 48 shows the counterframe element (01) and the pulley rail element (04); FIG. 51 shows the corner union element (21), FIG. 52 shows the half-column element (25) and the crossbar/column element (26); FIG. 53 shows the swing frame element (31); FIG. 54 shows the swing leaf element (37) and the max-air frame element (41), FIG. 55 shows the max-air leaf element (42) and the counterframe element (44); being that the upper fixation by separation between the frame guide element (09) and the upper sheet sealing element (10) applied in the three-plane frame element (17) and in the two-plane frame element (6) resulted in the minimum reduction of tenths of a millimeter, which is still obstructed by the anti-noise broom component element (D), so that when the fixation by screwing process in two parts was implemented, the two-plane rail profile elements (02) and two-plane rail support elements (03) were also separated into two distinct parts which have, combined with each other, insulation in the contacts by means of the component elements trims (G), which excluded any remaining vibration which interrupted the reverberation of the glass, even the friction of the movement of the work disappeared with the process of division of the component elements two-plane rail profiles (02) and two-plane rail support (03), as can be seen in FIGS. 30 and 35 and in detail on page 24, in the division of the two-plane rail elements (02), two-plane rail support elements (03) as well as in the connection that occurs between the maximum air frame profile elements (41) and maximum air sheet elements (42) with the counterframe elements (01); so that in the lower part of the three-plane, three-leaf sliding door (PF3), the base of the glass (I) is seated on a base (IC) sealed by a trim (G), supported on the sliding leaf profile (11), which has an internal channel for the trim (G) that internally accommodates a receptacle(S) secured by a screw (S1) and accommodates a pulley (SR) which slides on a pulley rail (04) whose sides are sealed by contact with broom-type baguettes (V) fitted in the channels (U) of the sliding leaf profile (11) and anti-noise brooms (D) fitted on the two-plane rail (02), which is supported on the rail support (13) and gutter extension (16) joined by a clip (PX) and sealed by trim (G), with the adoption of the device called “helping hand” for meeting leaves, which has as a differentiation a shim for vertical adjustment, to compensate for any irregularities in the plumb lines of the construction gap where the French window or door will be inserted. The perfect suitability of the rubber seal, which, due to the closing of the French window or door when pressed on the face of the vertical frame, promotes a wide and homogeneous seal; component elements such as laminated baguette (38), insulated baguette (39) and sheet baguette (40) are also used, which provides greater pressure, increasing acoustic insulation because it is screwed and not just fitted, which over time and use generates slack and new noises. The previously existing system used in doors and belonging to the state of the art, was focused on the pressure baguette with fitting with the unique possibility of increasing the thickness of the rubber, which, in addition to the structured seal element (GE), configures a corner joint profile element (21) which moves together with the leaf, forming an aesthetically symmetrical element on both sides. This vertical profile element (11) is configured as a corner, being fixed to one of the leaves that fits into the other leaf that moves towards it. In addition to thickened thickness and containing structured trim (GE);

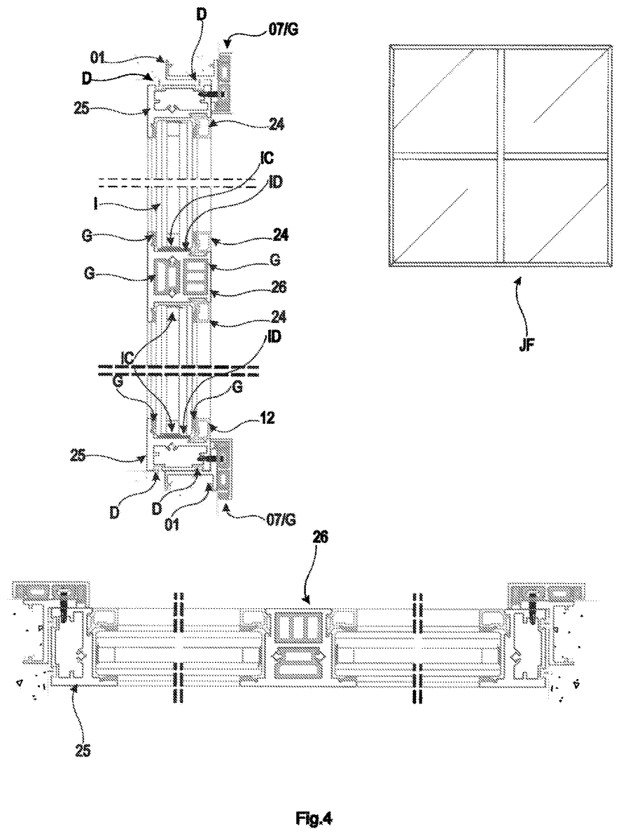

So that in mode 4—in fixed-leaf windows two by two fixed-leaf windows (JF) (FIG. 4) the transom column component (26) is positioned in the central part of the plan, and at the ends it is formed by the half-column profile (25) with laminated baguette (24); so that at the ends of each plane, the base of the glass panes (I) fixed by insulated baguette (12) have internal insulation by broom baguette (IC/ID) sealed by trim (G), supported on the half-column profile (25), which has internal sealing channels for trim (G), having channels for fitting anti-noise brooms (D) for sealing by contact with the work gap (Z) fitted into the half-column profile (25), being fixed by screw to the counterframe (01) as well as the finish (07) which has internal sealing channels for trim (G), so that the two-by-two fixed-leaf windows (JF) are formatted by the upper connection of the half-column profile (25) with the half-column profile (25) on the left side and right side and the lower connection of the half-column profile (25) with the plane being inserted flush with the counterframe (01) and next to the work gap (Z);

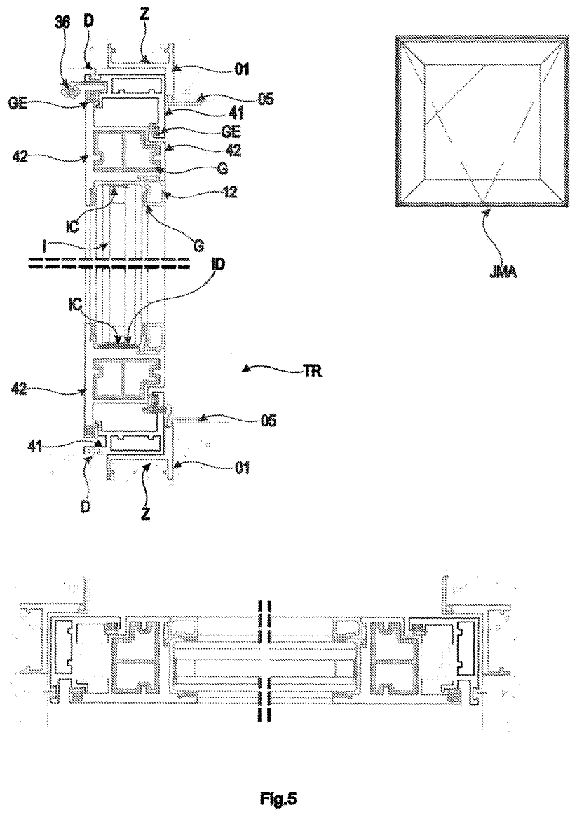

So in mode 5—in maximum air windows (JMA) (FIG. 5), the counterframe (01) is positioned at the ends flush with the work span (Z) with anti-noise brooms (D) for contact sealing and limitation by the finishing device (05) which has internal sealing channels for trim (G), being juxtaposed the maximum air frame (41) which has a channel for fitting the drip device (36), and for contact sealing of structured trim (GE) for maximum-air leaf profile (42), which internally has trim (G), so that at the ends of each plane, the base of the glasses (I) fixed by insulated baguette (12) have internal insulation by broom baguette (IC/ID) which has internal sealing channels for trim (G); being at the end of the base, the maximum air frame (41) fixed by a screw to the counterframe (01) thus limited by the finish (05); so that the maximum air window (JMA) is formatted by the upper connection of the profile with the maximum air leaf profile (42) with maximum air frame (41), on the left side and right side and the lower connection of the maximum air leaf profile (42) with maximum air frame (41), with the plane inserted flush with the counterframe (01) and next to the work gap (Z) with anti-noise brooms (D) for sealing by contact and opening by activating the latch (TR);

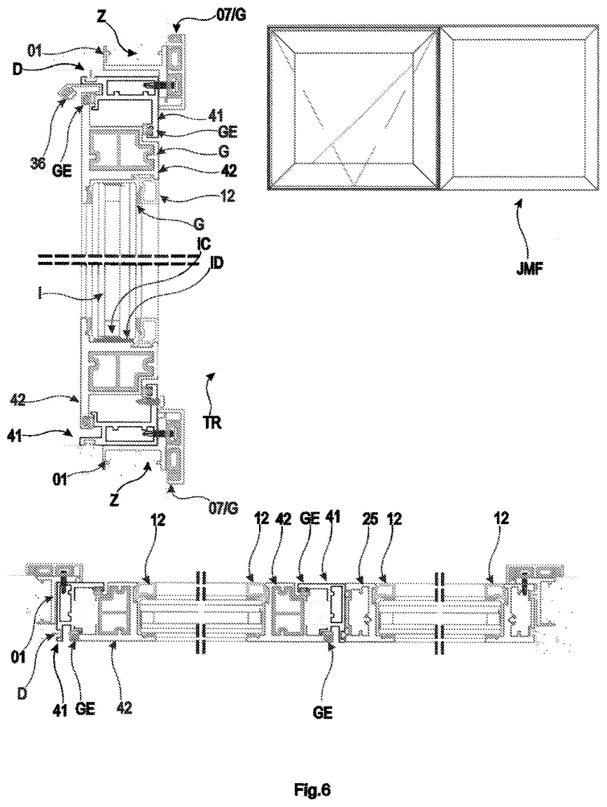

So that in mode 6—in the maximum air and fixed window (JMF) (FIG. 6), the counterframe (01) is positioned at the ends flush with the work span (Z) with anti-noise brooms (D) for contact sealing and screw fixing, the finishing device (07) which has internal sealing channels for trim (G), being juxtaposed the maximum air frame (41) which has a channel for fitting the drip device (36), and for contact sealing of structured trim (GE) for maximum-air leaf profile (42), which internally has trim (G), so that at the ends of each plane, the base of the glasses (I) fixed by insulated baguette (12) have internal insulation by broom baguette (IC/ID) which has internal sealing channels for trim (G), being at the end of the base, the maximum air frame (41) fixed by screw to the counterframe (01), so that in the part central part of the plan, the maximum air-leaf profile (42) is juxtaposed to the maximum air frame (41) with sealing by structured trim (GE), and juxtaposed to the half-column profile (25), with the glass (I) fixed by insulated baguette (12) on both sides of the plan, so that the maximum air and fixed window (JMF) is formatted by the upper connection of the maximum air-leaf profile (42) with the maximum air frame (41), on the left side and right side and the lower connection of the maximum air-leaf profile (42) with the maximum air frame (41), with the plan being inserted flush with the counterframe (01) and next to the work opening (Z) with anti-noise brooms (D) for sealing by contact and opening by activating the latch (TR);

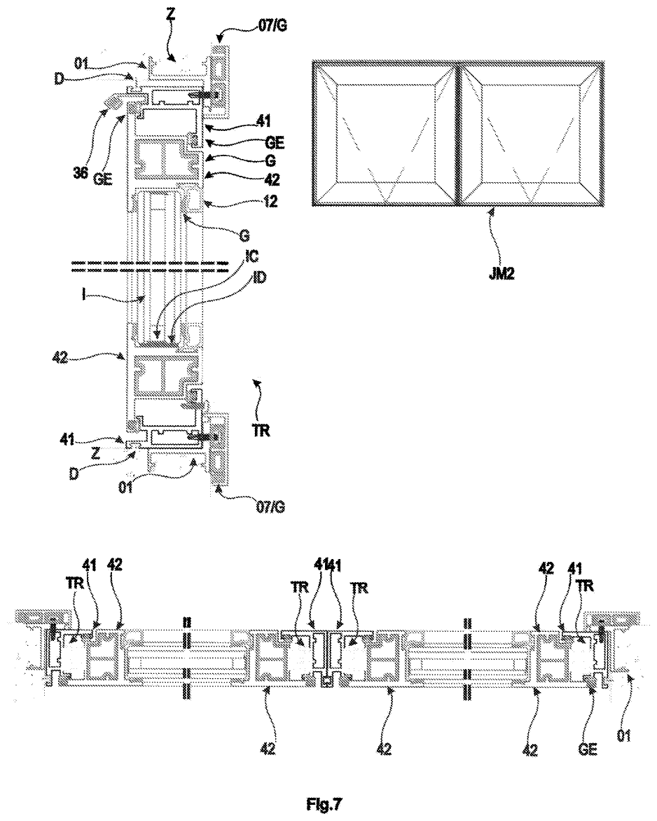

So that in mode 7—in the maximum air/maximum air window (JM2) (FIG. 7) the counterframe (01) is positioned at the ends flush with the work span (Z) with anti-noise brooms (D) for contact sealing and screw fixing, limited by the finishing device (07) which has internal sealing channels for trim (G), being juxtaposed the maximum air frame (41) which has a channel for fitting the drip device (36), and for contact sealing of structured trim (GE) for maximum-air leaf profile (42), which internally has trim (G), so that at the ends of each plane, the base of the glasses (I) fixed by insulated baguette (12) have internal insulation by broom baguette (IC/ID) sealed by trim (G), being at the end of the base, the maximum air frame (41) fixed by screw to the counterframe (01), so that in the central part of the plan, maximum leaf-air profile (42) with sealing by structured trim (GE) is juxtaposed to the maximum frame air (41) repeated in the opposite direction and juxtaposed to the half-column profile (25), with the glass (I) fixed by insulated baguette (12) on both sides of the plan, so that the maximum air and fixed window (JM2) is formatted by the upper connection of the maximum leaf-air profile (42) with maximum frame air profile (41), on the left side and right side and the lower connection of the maximum leaf-air profile (42) with maximum frame air profile (41, with the plan inserted flush with the counterframe (44) and next to the work span (Z) with anti-noise brooms (D) for sealing by contact and opening by actuation of the latch (TR) in two independent actuations as well as at the ends;

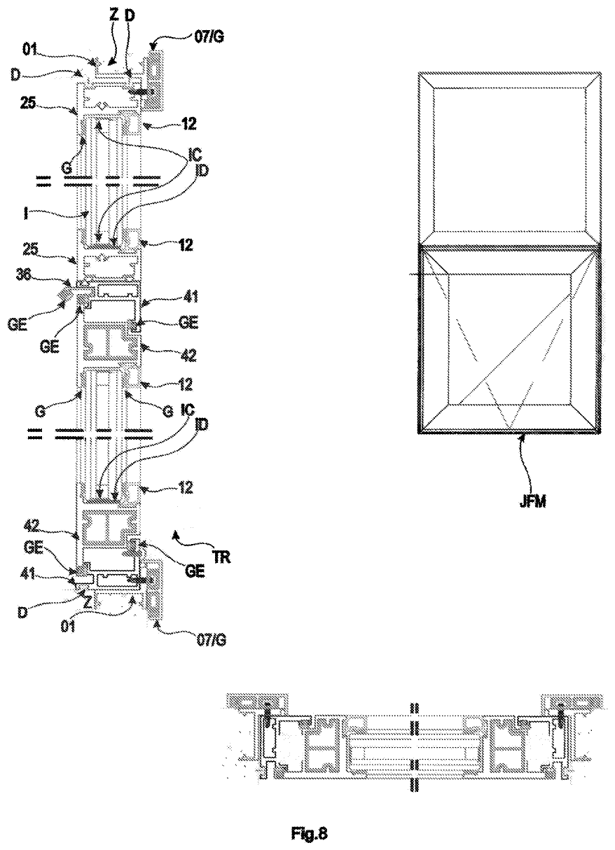

So in mode 8—in the fixed/maximum air window (JFM) (FIG. 8) the counterframe (01) is positioned at the ends flush with the work span (Z) with anti-noise brooms (D) for contact sealing and screw fixing, the finishing device (07) which has internal sealing channels for the trim (G), with the half-column profile (25) being juxtaposed, so that at the ends of each plane, the base of the glasses (I) fixed by insulated baguette fitting (12) have internal insulation by broom baguette (IC/ID) being at the end of the base, the half-column profile (25) is juxtaposed to the maximum air frame profile (41) which has a channel with a drip device (36) with structured trim (GE), and is juxtaposed to the maximum-air sheet profile (42) which has contact sealing by means of trim (G) having fixed by insulated baguette fitting (12) and by means of structural trims (GE) the contact with the maximum air frame profile (41) which has anti-noise brooms (D) when in contact with the gap in the work (Z) where the counterframe (01) is positioned and opening by activating the latch (TR); so that the fixed/maximum air window (JFM) is formatted by the upper connection of the maximum-air leaf profile (42) with the maximum air frame profile (41) on the left side and the right side and the lower connection, with the plane inserted flush with the counterframe (01) and next to the work opening (Z) with anti-noise brooms (D) for sealing by contact and opening by activating the latch (TR);

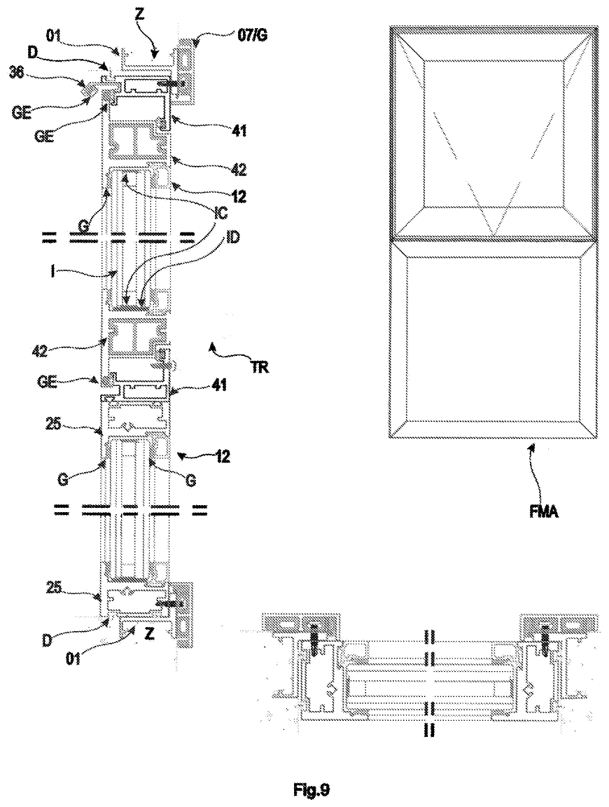

So in mode 9—maximum air/fixed window (FMA) (FIG. 9), the counterframe (01) is positioned at the ends flush with the work span (Z) with anti-noise brooms (D) for contact sealing and screw fixing, the finishing device (07) which has internal sealing channels for trim (G), with the maximum air frame profile (41) being juxtaposed and has a channel with a drip device (36) with structured trim (GE), the contact stops with the maximum-air leaf profile (42), so that at the ends of each plane, the base of the glasses (I) fixed by insulated baguette fitting (12) have internal insulation by broom baguette (IC/ID) and at the end of the base, the half-column profile (25) is juxtaposed to the counterframe (01), and is juxtaposed to the maximum-air leaf profile (42) which has contact sealing by means of trim (G) having been fixed by fitting insulated baguette (12) which has noise-reducing brooms (D) when in contact with the work space (Z) where the counterframe (01) is positioned and opening by activating the latch (TR), so that the maximum air/fixed window (FMA) is formatted by the upper connection of the maximum air frame profile (41) with the maximum air leaf profile (42) with the left side and right side and the lower connection with the half-column profile (25), with the plane being inserted flush with the counterframe (01) and next to the work space (Z) with noise-reducing brooms (D) for sealing by contact and opening by activating the latch (TR), with the central part composed of the maximum air leaf profile (42) and maximum air frame profile (41) connected by structured trim (GE);

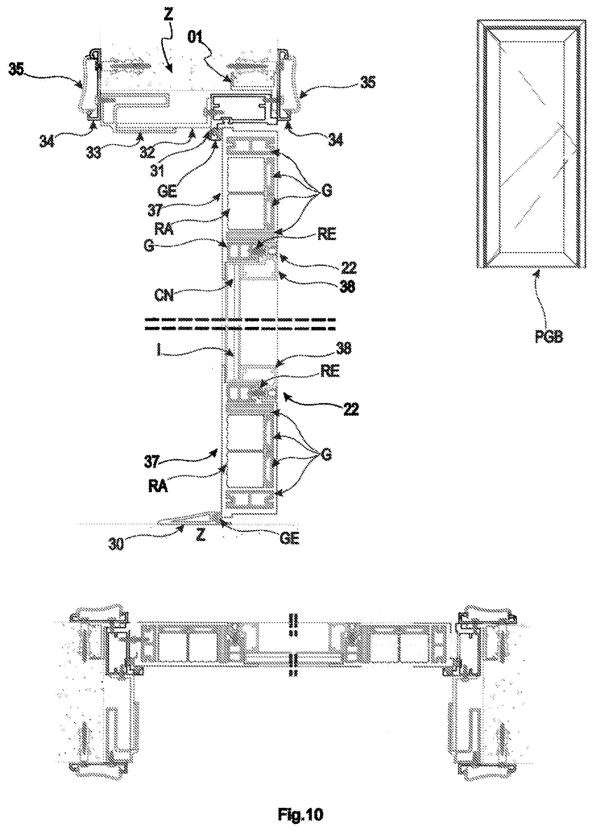

So that in mode 10—baguette swing door (PGB) (FIG. 10), in the gap of the work (Z) on both the front and rear faces, the finishing support profile (34) is fixed by screw and plug and fitted on the internal part, the finishing profile (35) that hides the screw that passes through the rear face, the counterframe (01) and also passes through the finishing support profile (34) to secure the turning frame profile (31) which has fixed by screw on the other side, the adjustment angle (32) that meets the adjustment frame profile (33) which in turn, positioned on the front face and fixed by screw, is another finishing support profile (34) that receives fitted on the internal part, the finishing profile (35) that hides another screw; so that the frame profile (31) has a structured trim (GE) fitted into the channel, which seals by contact with the sheet profile (37) which has a trim (G) internally in thickened and curved walls for acoustic retention (RA), being fixed by screw in the external recess (RE) of the sheet profile (37), the laminated baguette profile (38) by screw hidden by the corner union cover device (22), so as to form a channel (CN) in which the glass (I) is inserted in the upper part up to the lower part in which it is fitted in the recess of the sheet profile (37) secured by the laminated baguette profile (38) and by screw hidden by the corner union cover device (22), and the sheet profile (37) has a trim (G) internally in thickened and curved walls for acoustic retention (RA), being accommodated in the lower part next to the work span (Z) by a structured trim (GE) for sealing by contact with the device floor finish(30); finish (35) that hides the screw that passes through the rear face, the counterframe (01) and also passes through the finish support profile (34) to secure the pivot frame profile (31) which has fixed by a screw on the other side, the adjustment angle (32) that meets the adjustment frame profile (33) which in turn, positioned on the front face and fixed by a screw, is another finish support profile (34) that receives fitted on the inside, the finish profile (35) that hides another screw; so that the frame profile (31) has a structured trim (GE) fitted into the channel, which seals by contact with the leaf profile (37) which has a trim (G) internally in thickened and curved walls for acoustic retention (RA), being fixed by a screw in the external recess (RE) of the leaf profile (37), the insulated baguette profile (39) by a screw hidden by the corner union cover device (22), so as to form a channel (CN) in which it has internal insulation by broom baguette (IC) and the glass (I) is inserted in the upper part up to the lower part where it has internal insulation by broom baguette (IC) and in which it is fitted into the recess of the leaf profile (37) secured by the insulated baguette profile (39) and by a screw hidden by the corner union cover device (22), and the leaf profile (37) has a trim (G) internally in thickened walls and curved for acoustic retention (RA), being accommodated in the lower part next to the work opening (Z) by a structural trim (GE) for sealing by contact with the floor finishing device (30);

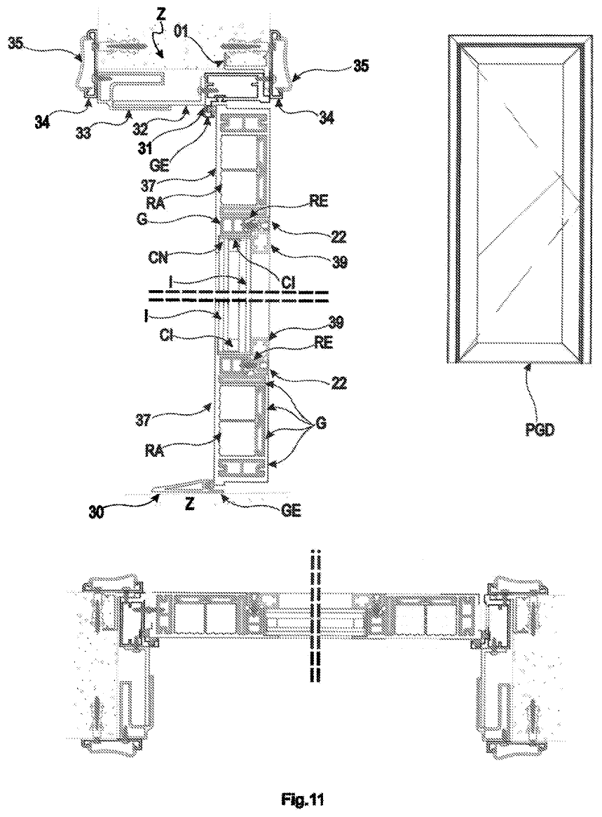

So that in mode 11—in the baguette swing door (PGD) (FIG. 11) in the work space(Z) on both front and back faces, the finish support profile (34) is fixed by screw and plug and fitted on the inside, the profile account of the closing of the French window or window when pressed on the face of the vertical frame and promotes a wide and homogeneous seal; still The previously existing system used in doors and belonging to the state of the art, was focused on the pressure baguette with fitting with a unique possibility of increasing the thickness of the rubber, which in addition to the structured trim element (GE) configures a corner joint profile element (21) which moves together with the leaf forming an aesthetically symmetrical element on both sides. This vertical profile element (11) is configured as a corner being fixed to one of the leaves that fits into the other leaf that moves towards it. In addition to thickened thickness and containing structured trim (GE);

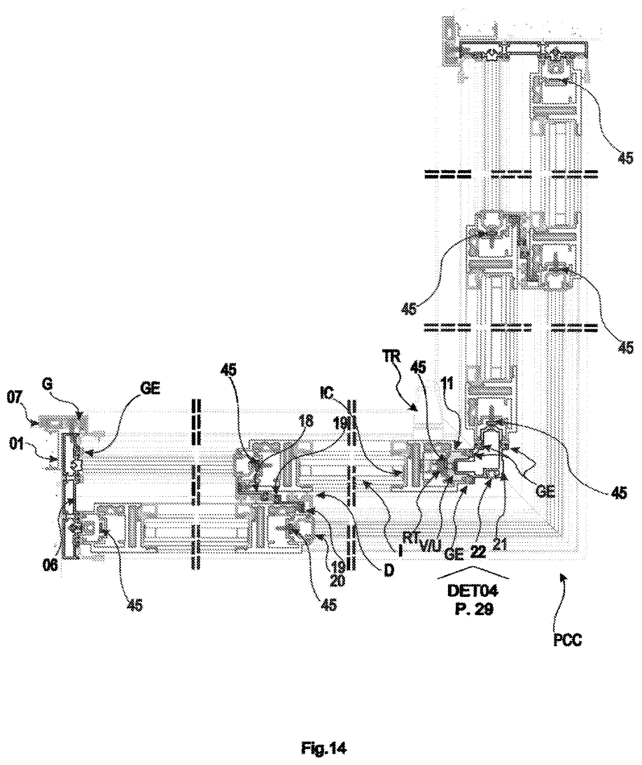

So that in mode 12—baguette swing door (PGV) (FIG. 14) in the work space (Z) on both the front and rear faces, the finishing support profile (34) is fixed by screw and plug and fitted on the internal part, the finishing profile (35) that hides the screw that passes through the rear face, the counterframe (01) and also passes through the finishing support profile (34) to secure the turning frame profile (31) which has fixed by screw on the other side, the adjustment angle (32) that meets the adjustment frame profile (33) which in turn, positioned on the front face and fixed by screw, is another finishing support profile (34) that receives fitted on the internal part, the finishing profile (35) that hides another screw; so that the frame profile (31) has a structured trim (GE) fitted into the channel, which seals by contact with the sheet profile (37) which has a trim (G) internally in thickened and curved walls for acoustic retention (RA), being fixed by screw in the external recess (RE) of the sheet profile (37), the sheet baguette profile (40) by screw hidden by the corner union cover device (22), so as to form a gap (W) and the sealed volume (V) is inserted in the upper part up to the lower part and in which it is fitted into the recess of the sheet profile (37) secured by the sheet baguette profile (40) and by screw hidden by the corner union cover device (22), and the sheet profile (37) has a trim (G) internally in thickened and curved walls for acoustic retention (RA), being accommodated in the lower part next to the work gap (Z) by a structure trim (GE) for contact sealing with floor finishing device(30);

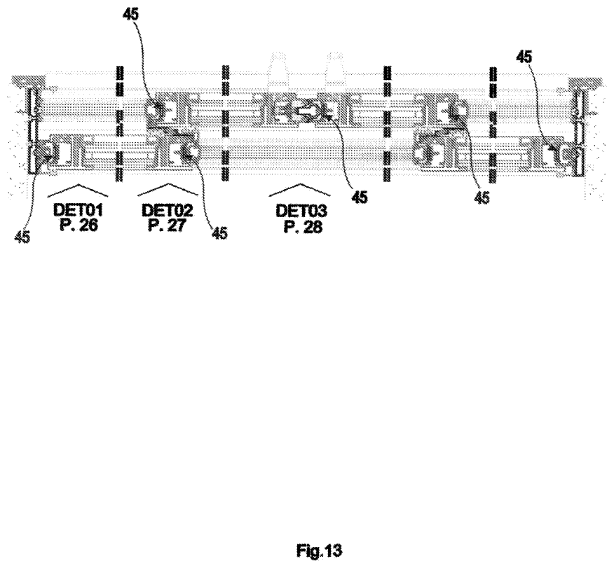

So in mode 13—2-plane 2-leaf sliding door (FIG. 13) in plan, laminated baguette (38), insulated baguette (39) and sheet baguette (40) component elements are used, which provides greater pressure, increasing acoustic insulation because it is screwed and not just fitted, which over time and use generates clearance and new noises, with the implementation of a “helping hand” for the meeting of leaves, a sealing device between leaves (19) with anti-noise brooms (D) and secured by a screw and central sealing cover (20), having inserted in the adjustment device between leaves (18) more structured trim units (GE) formatted in moldable structural rubber between themselves under pressure to activate the latches (TR), moving the device (RT) housed in the ends of the sliding leaf profile (11) of each unit of the door plane, which has as a differentiation a shim for vertical adjustment, to compensate for any irregularities in the vertical lines of the construction opening where the French window or French window will be inserted. The perfect suitability of the rubber seal, which

So that in mode 14—two-plane sliding door with corner (PCC) (FIG. 14), being screwed to the upper and lower sides of the internal and non-visible sliding leaf profile units (11), the vertical sealing element (45) with a coupled shim/brush element (CE) that serves to seal the gaps against the passage of wind, dust and sound, helping to reduce noise by compensating for the gap in the upper and lower part of the tracks, in cleaning the two-plane rail element (02), upper or lower three-plane rail (15) through the use of the shim/brush element (CE) conferring greater durability to the pulley rail element (04); considering that the increase in thickness (ME), mass and undulation (AB) in the profiles with internal application of rubbers (G), to obstruct the entry of wind, dust and sound and their dissipation and reverberation, enhancing the effects of the gap reduction; the increase in thickness (ME) in profiles with greater mass for acoustic obstruction represented in FIG. 49, sliding leaf element (11); FIG. 54, turning leaf element (37), type of profiles with greater mass for acoustic obstruction represented in FIG. 56, the sliding leaf element (11), the half-column element (25), the turning leaf element (37), the crossbar/column element (26), the maximum air leaf element (42); FIG. 48 shows the counterframe element (01) and the pulley rail element (04); FIG. 51 shows the corner joint element (21), FIG. 52 shows the half-column element (25) and the crossbar/column element (26); FIG. 53 shows the turning frame element (31); FIG. 54 shows the leaf pivot element (37) and the max-ar frame element (41); FIG. 55 shows the leaf max-ar element (42) and the counterframe element (44); being that the upper fixation by separation between the frame guide element (09) and the upper sheet sealing element (10) applied in the frame element (17) of three planes and in the frame element (6) of two planes resulted in the minimum reduction of tenths of a millimeter, which is still obstructed by the component element anti-noise brooms (D), so that when the fixation by screwing process was implemented in two parts, the two-plane rail profile elements (02) and two-plane rail support elements (03) were also separated into two distinct parts which have, combined with each other, insulation in the contacts by means of the component elements gaskets (G), which excluded any remaining vibration which interrupted the reverberation of the glass, even the friction of movement of the work disappeared with the process of division of the component elements two-plane rail profiles (02) and two-plane rail support elements (03), as can be seen in FIGS. 30 and 35 and in detail on page 24, in the division of the two-plane rail elements (02), rail support elements two planes (03) as well as in the connection that occurs between the maximum-air frame profile elements (41) and maximum-air leaf elements (42) with the counterframe elements (01); so that the two-plane and corner sliding door (PCC), is formatted at its ends of each plane by the connection of the sliding leaf profile (11) being the set formed in the upper part by the two-plane frame (06) with the two-plane frame (06) of the left side and right side of the work span (Z), which form the left and right jambs and connect the two-plane frame (06) that forms the base, and below, positioned the three-plane rail (15) is supported by the rail support (13) supported on the gutter (14) there is the extension of the gutter (16) for waste outlet (SR); being the adoption of the device called “friend's hand” for meeting leaves, which It has as a differentiation a shim for vertical adjustment, to compensate for any irregularities in the vertical lines of the construction opening where the French window or door will be inserted. The perfect adaptation of the rubber seal, which due to the closing of the French window or door when pressed on the face of the vertical frame and promotes a wide and homogeneous seal; it also uses component elements such as laminated baguette (38), insulated baguette (39) and sheet baguette (40) which provides greater pressure, increasing acoustic insulation because it is screwed and not just fitted which, over time and use, generates slack and new noises. The previously existing system used in doors and belonging to the state of the art, was focused on the pressure baguette with fitting with the unique possibility of increasing the thickness of the rubber, which in addition to the structured seal element (GE) configures a corner joint profile element (21) which moves together with the leaf forming an aesthetically symmetrical element on both sides. This vertical profile element (11) is configured as a corner element, being fixed to one of the sheets that fits into the other sheet that moves towards it. In addition to the thickened thickness and containing structured trim (GE), and in the central part at the intersection of each plane and at the end of the path there will be structured trim units (GE) formatted in moldable structured rubber under pressure to activate the latches (TR) that move to lock in each plane and when sliding two planes in the same direction, one plane may be connected to another by means of the adjustment device between leaves (18) constructive arrangement “helping hand” fixed by a screw at the vertical top hidden by a sealing device between leaves (19) with anti-noise brooms (D) and secured by a screw and central sealing cover (20), having inserted in the adjustment device between leaves (18) more structured trim units (GE) formatted in moldable structural rubber between themselves under pressure to activate the latches (TR) moving the device (RT) housed in the ends of the sliding leaf profile (11) of each unit of the door plane that have a final trajectory on one side in the frame of two planes (06) by means of contacts by structural trim (GE), and on the other hand, which on the other hand has a final trajectory occurs in the corner union profile (21) by means of contacts by structural trim (GE), with the corner union profile (21) fixed by a screw on the other side of the sliding sheet profile (11); so that the noise and dust sealing occurs by means of a sealing device between sheets (45) and shim/brush (CE), this device having a channel for internal fitting by broom baguette (IC) for insulation and sealing.

1-23. (canceled)

24. A noise-reducing system for use with one or more of: a frame, a door, and a French window, comprising:
a jamb guide configured for vertical sealing within one or more of a door plane, and a window plane;
at least one vertical sealing element disposed between a set of adjacent panes;
a noise-reducing brush sealing positioned along vertical edges of the frame to reduce transmission of one or more of wind, dust, and sound;
an upper pane sealing assembly and an insulated bead located at an upper portion of the frame to provide acoustic insulation;
a two-plane rail element and a two-plane rail support element, wherein the two-plane rail element and the two-plane rail support element are separate and combinable components;
a set of trim components to insulate one or more contact points between the two-plane rail element and the two-plane rail support element;
a horizontal sealing assembly comprising:
a structured trim element disposed at the corner of the frame;
a sealing element located between the set of adjacent panes;
a corner joint component, a central stop, a mid-column, a cross-member, and a corner plate, wherein the structured trim element, the sealing element, and the corner joint component, the central stop, the mid-column, the cross-member, and the corner plate are secured to form a continuous acoustic barrier with a symmetric aesthetic on opposing faces of the adjacent panes; and
a laminated bead component, an insulated bead, and a plate bead collectively forming an aesthetically symmetrical profile element on both interior and exterior sides of the adjacent panes, wherein the corner joint component moves in conjunction with a sliding pane;
a concealed vertical sealing element disposed within a profile of the sliding pane, wherein the concealed vertical sealing element is configured to seal a set of vertical gaps and reduce noise by compensating for an upper rail spacing portion and a lower rail spacing portion;
a brush block assembly positioned within a corner sealing structure, wherein the brush block cooperating with a sealing assembly to clean and seal the two-plane rail element, and a three-plane rail element; and
a set of internal rubber inserts configured to reduce the ingress and reverberation of at least one of wind, dust, and noise.

25. The noise-reducing system of claim 24, wherein the separation of the two-plane rail element and the two-plane rail support element into two distinct parts enables independent vibration dampening and enhanced structural insulation through interposed trim components.

26. The noise-reducing system of claim 24, wherein the concealed vertical sealing element is disposed within the sliding pane is configured to dynamically compensate for rail tolerance variations and reduce transmission of the wind, dust, and sound along the upper rail spacing portion and the lower rail spacing portion.

27. The noise-reducing system of claim 24, wherein the profiles include increased material thickness, mass, and surface undulation, and incorporate the internal rubber inserts to dissipate vibrational energy and block environmental noise to reduce sound reverberation.

28. A noise-reducing system for door and window assemblies, comprising:
a two-plane, four-leaf sliding door assembly comprising a plurality of sliding leaf profile elements, each including internal channels for receiving acoustic trim components and rubber gaskets;
a frame assembly comprising a two-plane frame element and a frame guide element configured to align a flush to reduce a gap between a frame and the two-plane, four-leaf sliding door assembly;
a rail assembly comprising a two-plane rail element and a corresponding two-plane rail support element, the two-plane rail profile and support element being constructed as separate parts configured for combined assembly with insulated contact trim components disposed there between;
an anti-noise broom sealing element disposed within at least one of the frame, and sliding door profiles to reduce the ingress of one or more of sound, wind, and dust;
a three-plane rail element positioned below the two-plane sliding assembly and supported by a gutter element and a rail support, wherein the gutter element comprises an extension for drainage;
a plurality of baguette elements comprising an insulated baguette and a laminated baguette secured to the sliding leaf profile elements and the frame to provide sealing pressure and enhanced acoustic insulation; and
a vertical sealing element positioned between adjacent sliding leaf profile elements, configured to seal vertical gaps between the panes and reduce sound transmission and rail friction during sliding motion.

29. The noise-reducing system of claim 28, wherein the anti-noise broom sealing element is positioned flush with the wall opening and includes a structured acoustic trim element for aesthetic symmetry on both sides of the door assembly.

30. The noise-reducing system of claim 28, wherein each sliding leaf profile element is configured to enhance acoustic containment and reduce reverberation.

31. The noise-reducing system of claim 28, wherein the baguette elements are secured to the profiles using a set of screw fasteners rather than press-fit connections to maintain pressure over time and prevent loosening.

32. The noise-reducing system of claim 28, further comprising a pulley rail element disposed within the rail profile, wherein the pulley rail element is configured to receive a pulley for sliding operation and sealed by contact with broom-equipped baguettes.

33. The noise-reducing system of claim 28, further comprising an adjustment shim element positioned between overlapping sliding leaf profiles for vertical plumb compensation during installation.

34. The noise-reducing system of claim 28, wherein the two-plane rail profile and rail support elements are insulated at their interface using acoustic trim elements to prevent structural vibration and eliminate reverberation through the profile.

35. The noise-reducing system of claim 28, further comprising a top leaf sealing baguette and lateral broom sealing elements that are disposed at an upper edge and a side edge of the sliding door to complete acoustic sealing.

36. A noise-proofing system, comprising:
a set of structural elements comprising a counterframe, a two-plane rail, a two-plane rail support, a pulley rail, at least one frame guide, and a two-plane frame;
a plurality of sealing components comprising an upper sheet seal, a set of seals between sheets, a central seal cover, a central stop, and an anti-noise broom seal;
a set of acoustic trim components comprising a set of structured trims and a set of insulated baguettes; and
a set of sheet and frame members comprising a sliding sheet, a set of laminated baguettes, a set of insulated baguettes, and a set of sheet baguettes, wherein the two-plane rail and two-plane rail support are configured to permit flush alignment with the frame during closure to reduce gaps between frame planes, and wherein the frame guide is configured to enable upper adjustment and positional alignment of the two-plane frame to minimize tolerance gaps and improve acoustic sealing.

37. The noise-proofing system of claim 36, wherein the anti-noise broom seal is integrally attached to the sliding sheet and configured to engage the rail during translational movement to prevent ingress of one or more of dust and sound.

38. The noise-proofing system of claim 36, wherein the structured trims are a set of multilayered acoustic components comprising internal damping material and external rigid facing for enhanced sound attenuation.

39. The noise-proofing system of claim 36, wherein the laminated baguette, the insulated baguette, and the sheet baguette are arranged to provide symmetrical visual aesthetics on both sides of the frame while providing continuous acoustic sealing.

40. The noise-proofing system of claim 36, wherein the corner joint and the corner joint cover form an angular interface sealed with a flexible insert to dampen structural vibrations and reduce flanking noise transmission.

41. The noise-proofing system of claim 36, wherein the pulley rail comprises a recessed track profile configured to accommodate concealed movement of the sliding sheet while maintaining an uninterrupted seal via the anti-noise broom.

42. The noise-proofing system of claim 36, wherein the frame guide comprises a telescoping engagement interface, an adjustable engagement interface that enables in-situ vertical alignment correction to compensate for installation tolerances.

43. The noise-proofing system of claim 36, wherein the two-plane frame comprises an embedded insulation layer and a mass-loaded profile core configured to obstruct the transmission of low-frequency environmental noise.
